(19) United States
(12) Patent Application Publication
(10) Pub. No.: US 2015/0193241 A1
(43) Pub. Date: Jul. 9, 2015

(54) MULTI-OPERATING SYSTEM MOBILE AND OTHER COMPUTING DEVICES WITH PROXY APPLICATIONS RUNNING UNDER A BROWSER

(71) Applicant: OpenMobile World Wide, Inc., Framingham, MA (US)

(72) Inventor: Thierno Diallo Hamzata, Framingham, MA (US)

(21) Appl. No.: 14/517,079

(22) Filed: Oct. 17, 2014

Related U.S. Application Data
(63) Continuation-in-part of application No. 14/061,288, filed on Oct. 23, 2013.
(60) Provisional application No. 61/984,976, filed on Apr. 28, 2014.
(60) Provisional application No. 61/983,698, filed on Apr. 24, 2014.
(60) Provisional application No. 61/892,896, filed on Oct. 18, 2013.
(60) Provisional application No. 61/717,764, filed on Oct. 24, 2012.
(60) Provisional application No. 61/717,731, filed on Oct. 24, 2012.

(51) Int. Cl. G06F 9/44; G06F 3/0484

(52) U.S. Cl. CPC G06F 9/4443; G06F 3/04842

(57) ABSTRACT

The invention provides, in some aspects, a computing device that includes a central processing unit that is coupled to a hardware interface and that executes a native operating system including one or more native runtime environments within which native software applications are executing. A first native software application executing within the one or more native runtime environments defines one or more hosted runtime environments within which hosted software applications are executing. One or more further native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

This application claims the benefit of priority of U.S. Patent Application Ser. No. 61/984,976, filed Apr. 28, 2014, entitled MULTI-OPERATING SYSTEM MOBILE AND OTHER COMPUTING DEVICES WITH PROXY APPLICATIONS RUNNING UNDER A BROWSER and U.S. Patent Application Ser. No. 61/983,698, filed Apr. 24, 2014, entitled HOSTED APP INTEGRATION SERVICES IN MULTI-OPERATING SYSTEM MOBILE AND OTHER COMPUTING DEVICES. This application is a continuation-in-part of U.S. patent application Ser. No. 14/061,288 (now, U.S. Patent Publication No. US 2014-0115606), filed Oct. 23, 2013, entitled “MULTI-PLATFORM MOBILE AND OTHER COMPUTING DEVICES AND METHODS,” which claims the benefit of filing of U.S. Patent Application Ser. No. 61/892,896, filed Oct. 18, 2013, entitled MULTI-PLATFORM MOBILE AND OTHER COMPUTING DEVICES AND METHODS, U.S. Patent Application Ser. No. 61/717,764, filed Oct. 24, 2012, entitled BRIDGING NOTIFICATION SYSTEMS, and U.S. Patent Application Ser. No. 61/717,731, also filed Oct. 24, 2012, entitled SEMANTICALLY DIFFERENT TASK MANAGEMENT SYSTEM IN A SINGLE OPERATING SYSTEM. The teachings of all of the foregoing are incorporated herein by reference.

### BACKGROUND OF THE INVENTION

The invention pertains to digital data processing and, more particularly, to methods and apparatus for executing on a single hardware/software platform applications (“apps”) made for execution on multiple different such platforms. The invention has application in supporting cross-platform compatibility among apps for smart mobile devices, e.g., smart phones, tablet computers, set-top boxes, connected televisions, in-vehicle infotainment systems, or in-flight entertainment systems, and the like, all by way of non-limiting example.

The smart mobile device market has grown nearly 40% in the past year, according to analysts. This has been fueled, to a large degree, by the sale of devices running variants of the open-source Linux and Android operating systems. While a boon to the marketplace, those devices suffer as a result of the lack of cross-compatibility of the apps developed for them. Thus, for example, apps developed for mobile devices running the Meego operating system do not run on those executing the Tizen or Android operating systems. That problem is compounded, of course, when one turns to operating systems of entirely different lineages. For example, apps developed for Tizen do not run on those running WebOS or Windows OS's; and so forth.

This is not just a problem for consumers who have purchase new mobile devices that lack compatibility with old apps. It is also a problem for manufacturers, carriers and others in the supply chain whose efforts to deliver new hardware/software platforms are stymied by the lack of a large ecosystem of available apps. App developers, too, suffer from fragmentation in the marketplace, since they may be forced to port apps to a variety of platforms in order to establish or maintain product viability.

A few prior art efforts to resolve cross-compatibility issues have met with limited success. For example, Acer's Aspire One supported dual boot modes: one for Windows OS and one for Android. However, the device could not run apps for both operating systems in a single mode.

In view of the foregoing, an object of the invention is to provide improved systems and methods for digital data processing. Another, more particular, object is to provide such systems and methods as support executing on a single hardware/software platform applications (“apps”) made for execution on multiple different hardware/software platforms. Still another object is to provide such systems and methods as support cross-platform compatibility among apps for smart mobile devices, e.g., smart phones, tablet computers, set-top boxes, connected televisions, in-vehicle infotainment systems, or in-flight entertainment systems and the like, all by way of non-limiting example.

These and other objects are evident in the text that follows and in the drawings.

### SUMMARY OF THE INVENTION

Multi-Operating System Mobile and Other Computing Devices

The foregoing are among the objects attained by the invention, which provides a computing device that includes a central processing unit that is coupled to a hardware interface (including at least a display and an associated video frame buffer) and that executes a native operating system including one or more native runtime environments within which native software applications are executing, where each such native software application has instructions for execution under the native operating system. A first native software application (“ACL”) executing within one or more of the native runtime environments defines one or more hosted runtime environments within which hosted software applications are executing. Thus, for example, according to some practices of the invention, the first native software application executes code comprising those hosted runtime environment or portions thereof (such as virtual machines); whereas, in other practices, the first native software application can, instead or in addition, effect the installation, instantiation and/or invocation of services/processes executing outside the context of that application that make up those environments or portions thereof. Each such hosted software application has instructions for execution under a hosted operating system that differs from the native operating system.

One or more of the hosted software applications executing within the runtime environments each executes instructions to interact with a user of the computing device via graphics generated (as part of a graphical user interface) by the respective hosted software application, using a hosted windowing subsystem that is common to the one or more hosted runtime environments. That windowing subsystem is coupled to, and loads, one or more buffers with those graphics.

One or more native software applications (“launch proxies”), each corresponding to a respective one of the hosted software applications and each associated with an icon or other identifier, that is presented on the hardware interface for selection by the user of the computing device, responds to notification of such selection by activating the respective hosted software application.

One or more further native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

The invention provides in other aspects a computing device, e.g., as described above, in which
the one or more native runtime environments notify applications executing within them, including the IO proxies, of user input made with respect to those applications, and
hosted software applications executing within the one or more hosted runtime environments receive notifications of events from a hosted event handler subsystem that forms part of the one or more hosted runtime environments and that is common to the one or more hosted software applications.

Each IO proxy responds to notification of user input by transmitting information with respect thereto received from the one or more native runtime environments to the hosted event handler, which notifies the hosted software application corresponding to IO proxy that received that notification of that user input.

Yet still other aspects of the invention provide a computing device, e.g., as described above, in which a first native software application installs an IO proxy and launch proxy for execution under the one or more native runtime environments in connection with installation of a respective hosted software application for execution under the one or more hosted runtime environments.

Related aspects of the invention provide a computing device, e.g., as described above, that is a mobile computing device, such as, by way of nonlimiting example, a smart phone, tablet computer, set-top box, connected television, in-vehicle infotainment system, or in-flight entertainment system.

Further related aspects of the invention provide a computing device, e.g., as described above, in which the hosted operating system is a Linux-based operating system, such as, by way of nonlimiting example, an Android-based operating system. In still further related aspects of the invention, the hosted and native operating systems are differing variants of Linux-based operating systems. And, in yet still further related aspects of the invention, the hosted and native operating systems are differing variants of Android-based operating systems.

Hosted Application Display in Multi-Operating System Mobile and Other Computing Devices

Further aspects of the invention provide a computing device that includes a central processing unit that is coupled to a hardware interface (including at least a display and an associated video frame buffer) and that executes a native operating system including one or more native runtime environments within which native software applications are executing. Each such native software application has instructions for execution under the native operating system.

A first native software application (“ACL”) executing within the one or more native runtime environments defines one or more hosted runtime environments within which hosted software applications are executing, e.g., the first native software application executes code comprising those environments (or portions thereof) and/or it effects the installation, instantiation and/or invocation of services/processes that make them (or portions thereof) up. Each such hosted software application has instructions for execution under a hosted operating system that differs from the native operating system.

One or more of the hosted software applications executing within the hosted runtime environments each executes instructions to interact with a user of the computing device via graphics generated, as part of a graphical user interface, by the respective hosted software application using a hosted windowing subsystem that is common to the one or more hosted runtime environments. Those graphics can be, for example, a graphical window representing execution of the respective hosted software application. That windowing subsystem is coupled to and loads one or more buffers with those graphics.

One or more native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

Related aspects of the invention provide a computing device, e.g., as described above, that is a mobile computing device, such as, by way of nonlimiting example, a smart phone, tablet computer, set-top box, connected television, in-vehicle infotainment system, or in-flight entertainment system.

Further related aspects of the invention provide a computing device, e.g., as described above, in which the hosted operating system is a Linux-based operating system, such as, by way of nonlimiting example, an Android-based operating system. In still further related aspects of the invention, the hosted and native operating systems are differing variants of Linux-based operating systems. And, in yet still further related aspects of the invention, the hosted and native operating systems are differing variants of Android-based operating systems.

Still further related aspects of the invention provide a computing device, e.g., as described above, in which each of the native software applications executes instructions to interact with the user of the computing device via graphics generated as part of a graphical user interface by the respective native software application using a native windowing subsystem that is common to the one or more native runtime environments. That windowing subsystem effects loading of the native frame buffer with those graphics for presentation on the display of the computing device.

Yet still further related aspects of the invention provide a computing device, e.g., as described above, in which the one or more buffers loaded by the hosted windowing subsystem is a virtual frame buffer.

Still yet further related aspects of the invention provide a computing device, e.g., as described above, in which the graphics generated by the hosted software applications using the hosted windowing subsystem are applications windows.

Further related aspects of the invention provide a computing device, e.g., as described above, in which any of the native operating system and the one or more native runtime environments effects loading of the native frame buffer with graphics representing a status bar for presentation on the display of the computing device. The native software applications corresponding to the hosted software applications (i.e., the IO proxies) effect writing to the video frame buffer of the graphics received from those hosted software applications so as to preserve presentation of the status bar on the display.

The invention provides in other aspects a computing device, e.g., as described above, in which (i) the one or more native runtime environments notify applications executing within them, including the IO proxies, of user input made with respect to those applications, and (ii) hosted software applications executing within the one or more hosted runtime environments receive notifications of events from a hosted event handler subsystem that forms part of the one or more hosted runtime environments and that is common to the one or more hosted software applications. Each IO proxy responds to notification of user input by transmitting information with respect thereto received from the one or more native runtime environments to the hosted event handler, which notifies the hosted software application corresponding to the IO proxy that received that notification of that user input.

According to other related aspects of the invention, a computing device, e.g., as described above, includes one or more further native software applications (“launch proxies”), each corresponding to a respective one of the hosted software applications and each associated with an icon or other identifier that is presented on the hardware interface for selection by the user of the computing device. Each launch proxy responds to notification of such selection by activating the respective hosted software application.

In related aspects of the invention, a launch proxy effects activation of the respective hosted software application by transmitting a launch message to the hosted event handler, which activates that hosted software application within one of more of the hosted runtime environments.

Yet still other aspects of the invention provide a computing device, e.g., as described above, in which the first native software application installs an IO proxy and launch proxy for execution under the one or more native runtime environments in connection with installation of a respective hosted software application for execution under the one or more hosted runtime environments.

User/Hosted Application Interaction in Multi-Operating System Mobile and Other Computing Devices

Other aspects of the invention provide a computing device that includes a central processing unit that is coupled to a hardware interface and that executes a native operating system including one or more native runtime environments within which native software applications are executing, where each such native software application has instructions for execution under the native operating system.

A first native software application (“ACL”) executing within the one or more native runtime environments defines one or more hosted runtime environments within which hosted software applications are executing, e.g., the first native software application executes code comprising those environments or portions thereof and/or it effects the installation, instantiation and/or invocation of services/processes that make them (or portions thereof) up. Each such hosted software application has instructions for execution under a hosted operating system that differs from the native operating system. One or more of the hosted software applications executing within the one or more hosted runtime environments receive notifications of events from a hosted event handler subsystem that forms part of the one or more hosted runtime environments and that is common to the one or more hosted software applications.

One or more native software applications (“IO proxies”), each executing within the one or more native runtime environments and each corresponding to a respective one of the one or more hosted software applications, receive notification of user input made with respect to them from the one or more native runtime environments. Each IO proxy responds to notification of user input by transmitting information with respect thereto received from the one or more native runtime environments to the hosted event handler, which notifies the hosted software application corresponding to the IO proxy that received that notification of that user input.

According to related aspects of the invention, the hardware interface of a computing device, e.g., as described above, includes a user input device such as, for example, a touch screen, keyboard, trackball, touch stick, and so forth, that is in communications coupling with the one or more native runtime environments. Those one or more native runtime environments respond to a touch or other user input from the input device by transmitting respective touch or other input data to a said IO proxy with respect to which the input was made.

Related aspects of the invention provide a computing device, e.g., as described above, that is a mobile computing device, such as, by way of nonlimiting example, a smart phone, tablet computer, set-top box, connected television, in-vehicle infotainment system, or in-flight entertainment system.

Further related aspects of the invention provide a computing device, e.g., as described above, in which the hosted operating system is a Linux-based operating system, such as, by way of nonlimiting example, an Android-based operating system. In still further related aspects of the invention, the hosted and native operating systems are differing variants of Linux-based operating systems. And, in yet still further related aspects of the invention, the hosted and native operating systems are differing variants of Android-based operating systems.

According to other related aspects of the invention, a computing device, e.g., as described above, includes one or more further native software applications (“launch proxies”), each corresponding to a respective one of the hosted software applications and each associated with an icon or other identifier that is presented on the hardware interface for selection by the user of the computing device. Each launch proxy responds to notification of such selection by activating the respective hosted software application.

In related aspects of the invention, a launch proxy effects activation of the respective hosted software application by transmitting a launch message to the hosted event handler, which activates that hosted software application within one of more of the hosted runtime environments.

Yet still other aspects of the invention provide a computing device, e.g., as described above, in which first native software application installs an IO proxy and launch proxy for execution under the one or more native runtime environments in connection with installation of a respective hosted software application for execution under the one or more hosted runtime environments.

Coordination of Foreground Application Tasks in Multi-Operating System Mobile and Other Computing Devices

According to further aspects of the invention, there is provided a computing device that includes a central processing unit that is coupled to a hardware interface (including at least a display and an associated video frame buffer) and that executes a native operating system including one or more native runtime environments within which native software applications are executing. Each such native software application has instructions for execution under the native operating system.

A first native software application (“ACL”) executing within the one or more native runtime environments defines one or more hosted runtime environments within which hosted software applications are executing, e.g., the first native software application executes code comprising those environments or portions thereof and/or it effects the installation, instantiation and/or invocation of services/processes that make them (or portions thereof) up. Each such hosted software application has instructions for execution under a hosted operating system that differs from the native operating system.

One or more of the hosted software applications executing within the one or more hosted runtime environments each executes instructions to interact with a user of the computing device via graphics generated as part of a graphical user interface by the respective hosted software application using a hosted windowing subsystem that is common to the one or more hosted runtime environments. That windowing subsystem is coupled to and loads one or more buffers with those graphics.

One or more native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

The native operating system and/or the one or more native runtime environments responds to user selection of an executing one of the native software applications by bringing a graphical window representing execution of that application to a foreground of the display and making it “active” within the one or more native runtime environments. According to related aspects of the invention, the first native software application, e.g., upon being brought to the foreground and/or being made active, effects making the first hosted software application active within the one or more hosted runtime environments as if it had been brought to the foreground in them.

According to related aspects of the invention, the hardware interface of a computing device, e.g., as described above, includes a user input device such as, for example, a touch screen, keyboard, trackball, touch stick, and so forth, that is in communications coupling with the IO proxies. An event handler executes within the one or more hosted runtime environments and is in communications coupling with the one or more hosted software applications. A IO proxy with respect to which a touch or other input data is received from the user input device transmits touch or other input data to the event handler, which notifies the corresponding hosted software application of same, e.g., thereby making it active within the one or more hosted runtime environments.

According to related aspects of the invention, in a computing device, e.g., as described above, the graphics generated as part of a graphical user interface by the respective hosted software application can be a graphical window representing execution of the respective hosted software application.

According to other related aspects of the invention, in a computing device, e.g., as described above, the windowing subsystem is coupled to and loads one or more buffers with those graphics. The first native software application determines whether the corresponding hosted software application is active in the one or more hosted application runtime environments using those one or more buffers.

Yet still further related aspects of the invention provide a computing device, e.g., as described above, in which the one or more buffers loaded by the hosted windowing subsystem is a virtual frame buffer.

According to further related aspects of the invention, the IO proxy with respect to which a touch or other input data is received from the user input device of a computing device, e.g., as described above, determines whether the corresponding hosted software application is active in the one or more hosted application runtime environments by checking whether a graphical window representing that application is in the virtual foreground and/or active in the aforesaid one or more buffers.

According to still further related aspects of the invention, the IO proxy with respect to which a touch or other input data is received from the user input device of a computing device, e.g., as described above, executes one or more waits upon being brought to the foreground and/or being made active, until determining that the corresponding hosted software application is active in the one or more hosted application runtime environments.

Yet still other aspects of the invention provide a computing device, e.g., as described above, in which a first native software application installs a said IO proxy for execution under the one or more native runtime environments in connection with installation of a respective hosted software application for execution under the one or more hosted runtime environments.

Related aspects of the invention provide a computing device, e.g., as described above, that is a mobile computing device, such as, by way of nonlimiting example, a smart phone, tablet computer, set-top box, connected television, in-vehicle infotainment system, or in-flight entertainment system.

Further related aspects of the invention provide a computing device, e.g., as described above, in which the hosted operating system is a Linux-based operating system, such as, by way of nonlimiting example, an Android-based operating system. In still further related aspects of the invention, the hosted and native operating systems are differing variants of Linux-based operating systems. And, in yet still further related aspects of the invention, the hosted and native operating systems are differing variants of Android-based operating systems.

Notification and Reply Adaptation for Hosted Applications in Multi-Operating System Mobile and Other Computing Devices

Further aspects of the invention provide a computing device that supports execution of applications under multiple operating systems and that adapts user notifications and replies for applications executing on non-native ones of those operating systems.

According to these aspects of the invention, there is provided a computing device, e.g., of the type described above, that includes a central processing unit that is coupled to a hardware interface (including at least a display and an associated video frame buffer) and that executes a native operating system including one or more native runtime environments within which native software applications are executing, where each such native software application has instructions for execution under the native operating system. A first native software application (“ACL”) executing within the one or more native runtime environments defines one or more hosted runtime environments within which hosted software applications are executing, e.g., the first native software application executes code comprising those environments or portions thereof and/or it effects the installation, instantiation and/or invocation of services/processes that make them (or portions thereof) up. Each such hosted software application has instructions for execution under a hosted operating system that differs from the native operating system.

The one or more native runtime environments include a common native notification subsystem that is in communications coupling with the native software applications and that marshals notifications generated by them for presentation to the user via the hardware interface.

The one or more hosted runtime environments include a common hosted notification subsystem that is in communications coupling with the hosted software applications and that marshals notifications generated by them for presentation to the user via the hardware interface. The hosted notification subsystem comprises instructions for execution under the hosted operating system and executes on the central processing unit within one of more of the hosted runtime environments. The native notification subsystem comprises instructions for execution under the native operating system and executes on the central processing unit within one of more of the hosted runtime environments.

A plurality of hosted software applications that each comprise instructions for execution under that hosted operating system execute on the central processing unit within one of more of the hosted runtime environments. One or more of those applications generate notifications for presentation to a user of the device and transmit those notifications to the hosted notification subsystem, which is in communications coupling with an adaptation layer that adapts notifications received from the one or more hosted software applications for, and transmits them to, the native hosted notification subsystem, which effects their presentation on the hardware interface of notifications from the hosted software applications.

Related aspects of the invention provide a computing device, e.g., as described above, in which the adaptation layer comprises a hosted component that includes instructions for execution under the hosted operating system and executes on the central processing unit within one of more of the hosted runtime environments, and a native component that includes instructions for execution under the native operating system and executes on the central processing unit within one of more of the native runtime environments.

Further related aspects of the invention provide a computing device, e.g., as described above, in which the hosted component of the adaptation layer communicates with the hosted software applications executing within the one or more hosted runtime environments via a first inter process communications (IPC) protocol, and in which the native component of the adaptation layer communicates with the native software applications executing within the one or more native runtime environments via a second IPC protocol.

Still further aspects of the invention provide a computing device, e.g., as described above, in which a first one of the plural hosted software applications and the first native software application, together, effect presentation of a graphical window representing execution of the first hosted software application on the display of the computing device. At least one of the native operating system and the one or more native runtime environments bring to a foreground of the display a graphical window representing execution of a native software application (i) which generated a notification for presentation by the native notification subsystem, and (ii) to which notification the user has responded—thereby making that native software application “active” within the one or more native runtime environments. According to these aspects of the invention, the first native software application, e.g., upon being brought to the foreground and/or being made active, effects making the first hosted software application active within the one or more hosted runtime environments as if it had been brought to the foreground in them.

According to further related aspects of the invention, the computing device, e.g., as described above, includes an event handler that executes within the hosted runtime execution environment and with which the first hosted application is in communications coupling. The first native software application responds to a touch or other user input from the input device by transmitting respective touch or other input data to the event handler, which notifies the first hosted application of same, e.g., thereby making it active within the one or more hosted runtime environments.

Still other aspects of the invention provide a computing device, e.g., as described above, in which the translation layer adapts notifications received from the one or more hosted software applications by converting them to a format presentable by the one or more native runtime environments via the user interface. Related aspects of the invention provide such a device in which the translation layer adapts notifications received from the one or more hosted software applications by converting them to a format displayable by the one or more native runtime environments via the display.

Still other aspects of the invention provide a computing device, e.g., as described above, in which the translation layer adapts notifications received from the one or more hosted software applications by mapping parameters of the notifications to corresponding parameters of the one or more native runtime environments.

Still other aspects of the invention provide a computing device, e.g., as described above, in which the translation layer adapts notifications received from the one or more hosted software applications that include messages that are to be delivered based on the user's interaction with the notification by registering the message with the first native software application and posting to the native notification subsystem a notification that includes a reference to that registered message in lieu of the message itself.

A related aspect of the invention provides a computing device, e.g., as described above, in which the first native software application responds to receipt, from the native notification subsystem, of a return message including such an aforesaid reference by effecting delivery to the first hosted software application of a reply message including the referenced registered message.

Hosted App Integration Services in Multi-Operating System Mobile and Other Computing Devices

Further aspects of the invention provide a computing device, e.g., as described above, that includes a central processing unit that is coupled to a hardware interface (including at least a display and an associated video frame buffer) and that executes a native operating system including one or more native runtime environments within which native software applications are executing, where each such native software application has instructions for execution under the native operating system.

A first native software application (“ACL”) executing within one or more of the native runtime environments effects installation, instantiation and/or invocation of services/processes that run outside the context of the first native software application and that make up one or more hosted runtime environments within which hosted software applications are executing (or portions of those runtime environments) and may, according to some aspects of the invention, execute the hosted runtime environments and/or portions thereof. Each such hosted software application has instructions for execution under a hosted operating system that differs from the native operating system.

One or more of the hosted software applications executing within the runtime environments each executes instructions to interact with a user of the computing device via graphics generated (as part of a graphical user interface) by the respective hosted software application, using a hosted windowing subsystem that is common to the one or more hosted runtime environments. That windowing subsystem is coupled to, and loads, one or more buffers with those graphics.

One or more native software applications (“launch proxies”), each corresponding to a respective one of the hosted software applications and each associated with an icon or other identifier, that is presented on the hardware interface for selection by the user of the computing device, responds to notification of such selection by activating the respective hosted software application.

One or more further native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

Hosted Application Display

Further aspects of the invention provide a computing device, e.g., as described above, that includes a central processing unit that is coupled to a hardware interface (including at least a display and an associated video frame buffer) and that executes a native operating system including one or more native runtime environments within which native software applications are executing. Each such native software application has instructions for execution under the native operating system.

A first native software application (“ACL”) executing within one or more of the native runtime environments effects installation, instantiation and/or invocation of services/processes that run outside the context of the first native software application and that make up one or more hosted runtime environments within which hosted software applications are executing (or portions of those runtime environments) and may, according to some aspects of the invention, execute the hosted runtime environments and/or portions thereof. Each such hosted software application has instructions for execution under a hosted operating system that differs from the native operating system.

One or more of the hosted software applications executing within the hosted runtime environments each executes instructions to interact with a user of the computing device via graphics generated, as part of a graphical user interface, by the respective hosted software application using a hosted windowing subsystem that is common to the one or more hosted runtime environments. Those graphics can be, for example, a graphical window representing execution of the respective hosted software application. That windowing subsystem is coupled to and loads one or more buffers with those graphics.

One or more native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

User/Hosted Application Interaction

Other aspects of the invention provide a computing device, e.g., as described above, that includes a central processing unit that is coupled to a hardware interface and that executes a native operating system including one or more native runtime environments within which native software applications are executing, where each such native software application has instructions for execution under the native operating system.

A first native software application (“ACL”) executing within one or more of the native runtime environments effects installation, instantiation and/or invocation of services/processes that run outside the context of the first native software application and that make up one or more hosted runtime environments within which hosted software applications are executing (or portions of those runtime environments) and may, according to some aspects of the invention, execute the hosted runtime environments and/or portions thereof. Each such hosted software application has instructions for execution under a hosted operating system that differs from the native operating system. One or more of the hosted software applications executing within the one or more hosted runtime environments receive notifications of events from a hosted event handler subsystem that forms part of the one or more hosted runtime environments and that is common to the one or more hosted software applications.

One or more native software applications (“IO proxies”), each executing within the one or more native runtime environments and each corresponding to a respective one of the one or more hosted software applications, receive notification of user input made with respect to them from the one or more native runtime environments. Each IO proxy responds to notification of user input by transmitting information with respect thereto received from the one or more native runtime environments to the hosted event handler, which notifies the hosted software application corresponding to the IO proxy that received that notification of that user input.

Coordination of Foreground Application Tasks

According to further aspects of the invention, there is provided a computing device, e.g., as described above, that includes a central processing unit that is coupled to a hardware interface (including at least a display and an associated video frame buffer) and that executes a native operating system including one or more native runtime environments within which native software applications are executing. Each such native software application has instructions for execution under the native operating system.

A first native software application (“ACL”) executing within one or more of the native runtime environments effects installation, instantiation and/or invocation of services/processes that run outside the context of the first native software application and that make up one or more hosted runtime environments within which hosted software applications are executing (or portions of those runtime environments) and may, according to some aspects of the invention, execute the hosted runtime environments and/or portions thereof. Each such hosted software application has instructions for execution under a hosted operating system that differs from the native operating system.

One or more of the hosted software applications executing within the one or more hosted runtime environments each executes instructions to interact with a user of the computing device via graphics generated as part of a graphical user interface by the respective hosted software application using a hosted windowing subsystem that is common to the one or more hosted runtime environments. That windowing subsystem is coupled to and loads one or more buffers with those graphics.

One or more native software applications (“IO proxies”), each executing within the one or more native runtime environments and each corresponding to a respective one of the one or more hosted software applications, receives the graphics generated by the respective hosted software application and effects writing of those graphics to the video frame buffer for presentation on the display of the computing device.

The native operating system and/or the one or more native runtime environments responds to user selection of an executing one of the native software applications by bringing a graphical window representing execution of that application to a foreground of the display and making it “active” within the one or more native runtime environments. According to related aspects of the invention, the first native software application, e.g., upon being brought to the foreground and/or being made active, effects making the first hosted software application active within the one or more hosted runtime environments as if it had been brought to the foreground in them.

Notification and Reply Adaptation for Hosted Applications

Further aspects of the invention provide a computing device, e.g., as described above, that supports execution of applications under multiple operating systems and that adapts user notifications and replies for applications executing on non-native ones of those operating systems.

According to these aspects of the invention, there is provided a computing device, e.g., of the type described above, that includes a central processing unit that is coupled to a hardware interface (including at least a display and an associated video frame buffer) and that executes a native operating system including one or more native runtime environments within which native software applications are executing, where each such native software application has instructions for execution under the native operating system. A first native software application (“ACL”) executing within one or more of the native runtime environments effects installation, instantiation and/or invocation of services/processes that run outside the context of the first native software application and that make up one or more hosted runtime environments within which hosted software applications are executing (or portions of those runtime environments) and may, according to some aspects of the invention, execute the hosted runtime environments and/or portions thereof. Each such hosted software application has instructions for execution under a hosted operating system that differs from the native operating system.

The one or more native runtime environments include a common native notification subsystem that is in communications coupling with the native software applications and that marshals notifications generated by them for presentation to the user via the hardware interface.

The one or more hosted runtime environments include a common hosted notification subsystem that is in communications coupling with the hosted software applications and that marshals notifications generated by them for presentation to the user via the hardware interface. The hosted notification subsystem comprises instructions for execution under the hosted operating system and executes on the central processing unit within one of more of the hosted runtime environments. The native notification subsystem comprises instructions for execution under the native operating system and executes on the central processing unit within one of more of the hosted runtime environments.

A plurality of hosted software applications that each comprise instructions for execution under that hosted operating system execute on the central processing unit within one of more of the hosted runtime environments. One or more of those applications generate notifications for presentation to a user of the device and transmit those notifications to the hosted notification subsystem, which is in communications coupling with an adaptation layer that adapts notifications received from the one or more hosted software applications for, and transmits them to, the native hosted notification subsystem, which effects their presentation on the hardware interface of notifications from the hosted software applications.

Multi-Operating System Mobile and Other Computing Devices with Proxy Applications Running Under a Browser

Further aspects of the invention provide a computing device, e.g., as described above, that includes a central processing unit that is coupled to a hardware interface (including at least a display) and that executes a native operating system including one or more native runtime environments within which one or more native software applications—including at least a browser—are executing, where each such native software application has instructions for execution under the native operating system.

The central processing unit additionally executes one or more applications and/or processes (collectively, “processes”) providing services that make up one or more hosted runtime environments (or portions thereof) within which one or more hosted software applications are executing. Each such hosted software application has instructions for execution under a hosted operating system that differs from the application execution environment defined within the browser and that may also differ from the native operating system.

One or more applications (“proxies”) executing within the browser, each corresponding to a respective one of the hosted software applications and each associated with an icon or other identifier that is presented on the hardware interface for selection by the user of the browser, responds to notification of such selection by activating the respective hosted software application.

The browser defines an application execution environment for executing applications in Javascript, HTML5, CSS or other scripting/programming languages common to web apps. Though referred to here and throughout this document as an application, the term “browser” as used herein also refers to layers within a software stack or architecture executing the computing device. An example of such a browser “application” is the Gecko layer of the commercially available on Mozilla's Firefox Operating System (Firefox OS).

In some aspects of the invention, the browser is a “web browser” of the type that, additionally, permits users to access and navigate resources (such as web pages) on a network such as the Internet, an extranet and so forth. Examples of such browsers include Mozilla's Firefox™, Google's Chrome™, Apple's Safari™ and so forth.

Hosted Application Display

Further aspects of the invention provide a computing device, e.g., as described above, that includes a central processing unit that is coupled to a hardware interface (including at least a display) and that executes a native operating system including one or more native runtime environments within which one or more native software applications—including at least a browser—are executing, where each such native software application has instructions for execution under the native operating system.

The central processing unit additionally executes one or more applications and/or processes (collectively, “processes”) providing services that make up one or more hosted runtime environments (or portions thereof) within which one or more hosted software applications are executing. Each such hosted software application has instructions for execution under a hosted operating system that differs from the application execution environment defined within the browser and that may also differ from the native operating system.

One or more of the hosted software applications executing within the hosted runtime environments each executes instructions to interact with a user of the computing device via graphics generated (as part of a graphical user interface) by the respective hosted software application, using a hosted windowing subsystem that is common to the one or more hosted runtime environments. That windowing subsystem is coupled to, and loads, one or more buffers with those graphics.

One or more applications (“proxies”) executing within the browser, each corresponding to a respective one of the one or more hosted software applications, receives the graphics generated by the respective hosted software application and effects writing of those graphics to the video frame buffer for presentation on the display of the computing device.

User/Hosted Application Interaction

Further aspects of the invention provide a computing device, e.g., as described above, that includes a central processing unit that is coupled to a hardware interface (including at least a display) and that executes a native operating system including one or more native runtime environments within which one or more native software applications—including at least a browser—are executing, where each such native software application has instructions for execution under the native operating system.

The central processing unit additionally executes one or more applications and/or processes (collectively, “processes”) providing services that make up one or more hosted runtime environments (or portions thereof) within which one or more hosted software applications are executing. Each such hosted software application has instructions for execution under a hosted operating system that differs from the application execution environment defined within the browser and that may also differ from the native operating system.

One or more of the hosted software applications executing within the one or more hosted runtime environments receive notifications of events from a hosted event handler subsystem that forms part of the one or more hosted runtime environments and that is common to the one or more hosted software applications.

One or more applications (“proxies”) executing within the browser, each corresponding to a respective one of the one or more hosted software applications, receive notification of user input made with respect to them from the one or more native runtime environments and/or from the browser. Each proxy responds to notification of user input by transmitting information with respect thereto received from the one or more native runtime environments to the hosted event handler, which notifies the hosted software application corresponding to the proxy that received that notification of that user input.

Coordination of Foreground Application Tasks

Further aspects of the invention provide a computing device, e.g., as described above, that includes a central processing unit that is coupled to a hardware interface (including at least a display) and that executes a native operating system including one or more native runtime environments within which one or more native software applications—including at least a browser—are executing, where each such native software application has instructions for execution under the native operating system.

The central processing unit additionally executes one or more applications and/or processes (collectively, “processes”) providing services that make up one or more hosted runtime environments (or portions thereof) within which one or more hosted software applications are executing. Each such hosted software application has instructions for execution under a hosted operating system that differs from the application execution environment defined within the browser and that may also differ from the native operating system.

The native operating system and/or the one or more native runtime environments responds to user selection of an executing one of the native software applications by bringing a graphical window representing execution of that application to a foreground of the display and making it “active” within the one or more native runtime environments. One or more applications (“proxies”) executing within the browser, each corresponding to a respective one of the hosted software applications, responds to begin brought to the foreground and/or being made active, by making the corresponding hosted software application active within the one or more hosted runtime environments as if it had been brought to the foreground in them.

Notification and Reply Adaptation for Hosted Applications

Further aspects of the invention provide a computing device, e.g., as described above, that includes a central processing unit that is coupled to a hardware interface (including at least a display) and that executes a native operating system including one or more native runtime environments within which one or more native software applications—including at least a browser—are executing, where each such native software application has instructions for execution under the native operating system.

The central processing unit additionally executes one or more applications and/or processes (collectively, “processes”) providing services that make up one or more hosted runtime environments (or portions thereof) within which one or more hosted software applications are executing. Each such hosted software application has instructions for execution under a hosted operating system that differs from the application execution environment defined within the browser and that may also differ from the native operating system.

The one or more native runtime environments and/or the browser include a common native notification subsystem that is in communications coupling with applications executing under the browser and that marshals notifications generated by them for presentation to the user via the hardware interface.

The one or more hosted runtime environments likewise include a common hosted notification subsystem that is in communications coupling with the hosted software applications and that marshals notifications generated by them for presentation to the user.

A plurality of hosted software applications that each comprise instructions for execution under that hosted operating system execute on the central processing unit within one of more of the hosted runtime environments. One or more of those applications generate notifications for presentation to a user of the device and transmit those notifications to the hosted notification subsystem, which is in communications coupling with an adaptation layer that adapts notifications received from the one or more hosted software applications for, and transmits them to, the common native notification subsystem, which effects their presentation on the hardware interface of notifications from the hosted software applications.

The foregoing and other aspects of the invention are evident in the discussion that follows and in the drawings.

### BRIEF DESCRIPTION OF THE DRAWINGS

A more complete understanding of the invention may be attained by reference to the drawings, in which:

FIGS. 1A-1C depict a computing device of the type embodying the invention;

FIG. 2 depicts a native operating system of the type executing in the device of FIG. 1;

FIG. 3 depicts one or more hosted runtime environments defined by a native software application for execution of hosted software applications in the device of FIG. 1;

FIG. 4 depicts the interaction of components in launching an exemplary hosted software application based on user interaction with that application's launch proxy executing in a native runtime environment, displaying an application window representing operation of the hosted software application via that application's IO proxy, and transmitting user input from that proxy back to the hosted application;

FIG. 5 is a block diagram illustrating task operations in both the hosted application runtime environment and the native application runtime environment, and a one-to-one correspondence between hosted application tasks and proxy tasks, in accordance with an embodiment of the invention;

FIG. 6 is a block diagram illustrating the relationships between proxy tasks in the native application runtime environment and the complex task models and virtual frame buffer of the hosted application runtime environment, according to the task switching method of FIG. 8;

FIG. 7 is a flow chart illustrating a task switching method occurring in both the hosted application runtime environment and the native application runtime environment of the device of FIG. 5, in accordance with an embodiment of the invention;

FIG. 8 depicts interaction of the notification subsystems of the hosted runtime environments and native runtime environments in a system according to the invention

FIG. 9 depicts a notification translation function in a system according to the invention;

FIGS. 10-12 are flowcharts depicting notification translation in a system according to the invention; and

FIGS. 13-14 parallel FIGS. 2-3 and depict implementations of hosted runtime environments in systems utilizing daemons according to some practices of the invention.

FIG. 15 parallels FIG. 13 and depicts implementations of runtime environments in systems in which host proxies execute in a browser.

### DETAILED DESCRIPTION OF THE ILLUSTRATED EMBODIMENT

Architecture

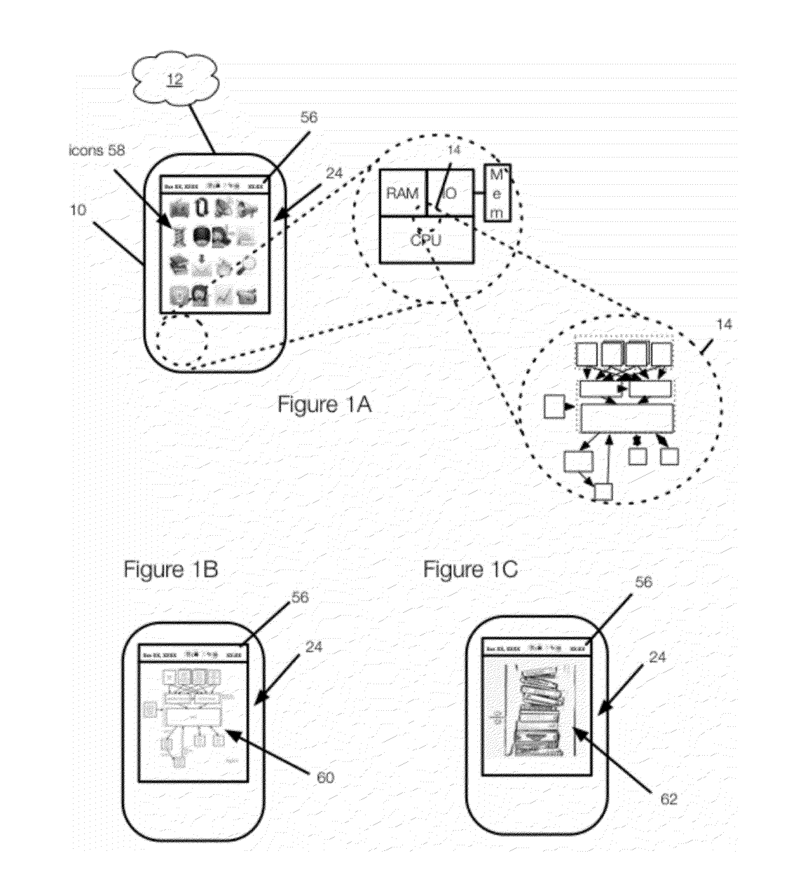

FIG. 1A depicts a computing device 10 of the type embodying the invention. The illustrated device 10 includes a central processing unit (CPU), input/output (I/O), memory (RAM) and nonvolatile storage (MEM) subsections, of the type commonly provided computing devices of the type commercially available in the marketplace, all as adapted in accord with the teachings hereof. In the illustrated embodiment, the device 10 comprises a mobile computing device, such as a smart phone or tablet computer, though, in other embodiments it may comprise other computing devices, mobile or otherwise, e.g., a set-top box, connected television, in-vehicle infotainment system, or in-flight entertainment system, just to name a few.

The device 10 may be connected permanently, intermittently or otherwise to one or more other computing devices, servers, or other apparatus capable of digital communications (not shown) by a network, here, depicted by “cloud” 12, which may comprise an Internet, metropolitan area network, wide area network, local area network, satellite network, cellular network, point-to-point network and/or a combination of one or more of the foregoing, in the conventional manner known in the art, as adapted in accord with the teachings hereof.

The CPU of device 10 (e.g., in conjunction with the I/O, RAM and/or MEM subsections) executes a native operating system 14 of the type commercially available in the marketplace, as adapted in accord with the teachings hereof. Examples of such operating systems include the Meego, Tizen, Android, WebOS, and Linux operating systems, to name just a few. More generally and/or in addition, the native operating system 14 can be a Linux-based operating system, such as, by way of nonlimiting example, an Android-based operating system.

Native Runtime Environment(s)

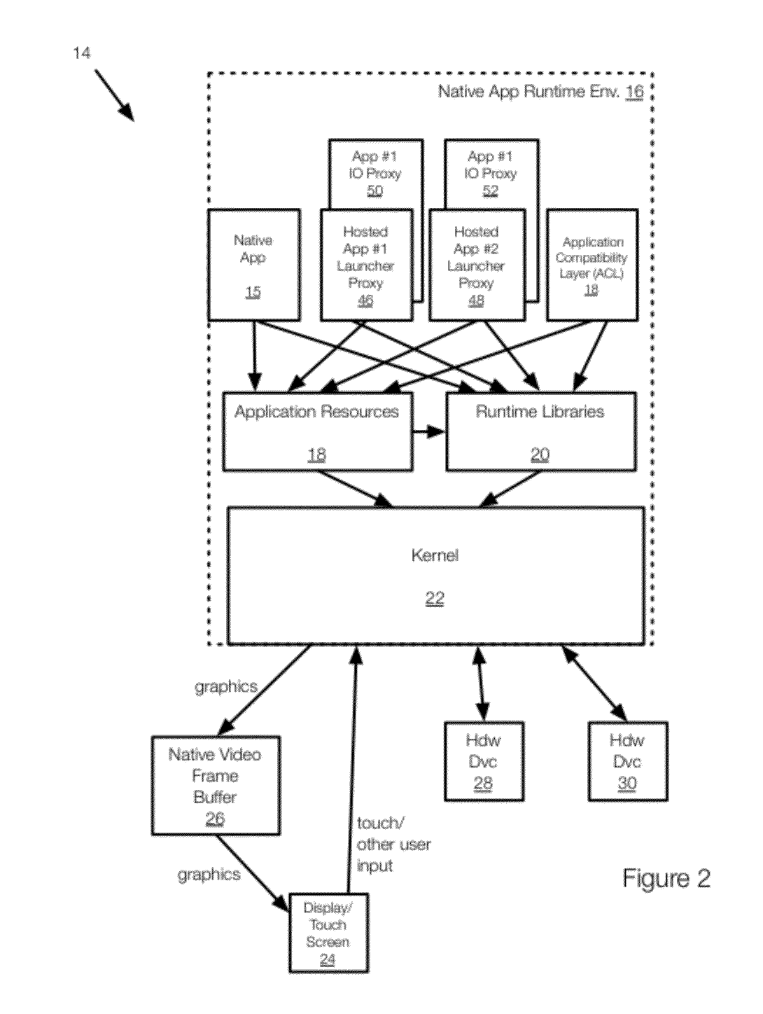

FIG. 2 depicts a native operating system 14 of the type executing on illustrated device 10 of FIG. 1.

Referring to that drawing, the native operating system 14 defines one or more native runtime environments 16 of the type known in the art (as adapted in accord with the teachings hereof) within which native software applications of the type known in the art (as adapted in accord with the teachings hereof)—i.e., applications having instructions for execution under the native operating system—are executing. Such applications are labeled 15, 18 and 46-52 in the drawing. As used here and elsewhere herein, the terms “application” and “app” are used interchangeably.

The native runtime environment(s) 16 may comprise one or more virtual machines or otherwise, as is conventional in the art (as adapted in accord with the teachings hereof), depending on the native operating system 14 and the specifics of its implementation on device 10. Illustrated native runtime environment 16 includes, by way of nonlimiting example, application resources 19 and runtime libraries 20, all of the type known in the art, as adapted in accord with the teachings hereof. That runtime environment 16 also includes a kernel 24 of the type known in the art, as adapted in accord with the teachings hereof.

Kernel 24 (or alternate functionality provided in the runtime environment(s) of alternate embodiments) serves inter alia as an interface, in the conventional manner known in the art has adapted in accord with the teachings hereof, between CPU 12 (and, more typically, the native applications executing within the native runtime environment 16 executing thereon) and hardware devices 24-30 integral or attached to device 10. This includes display/touch screen 24 and the frame buffer 26 that drive displays thereon in the conventional manner known in the art, as adapted in accord with the teachings hereof. This can also include, by way of non-limiting example, a keyboard, trackball, touch stick, other user input devices, and/or other integral or peripheral devices of the type known in the art. In the discussion that follows, the display/touch screen 24, the frame buffer 26, and other integral/peripheral devices supporting interactions between the device 10 and its user are referred to as a “hardware interface,” regardless of whether they comprise hardware, software or (as is more typically the case) a combination thereof.

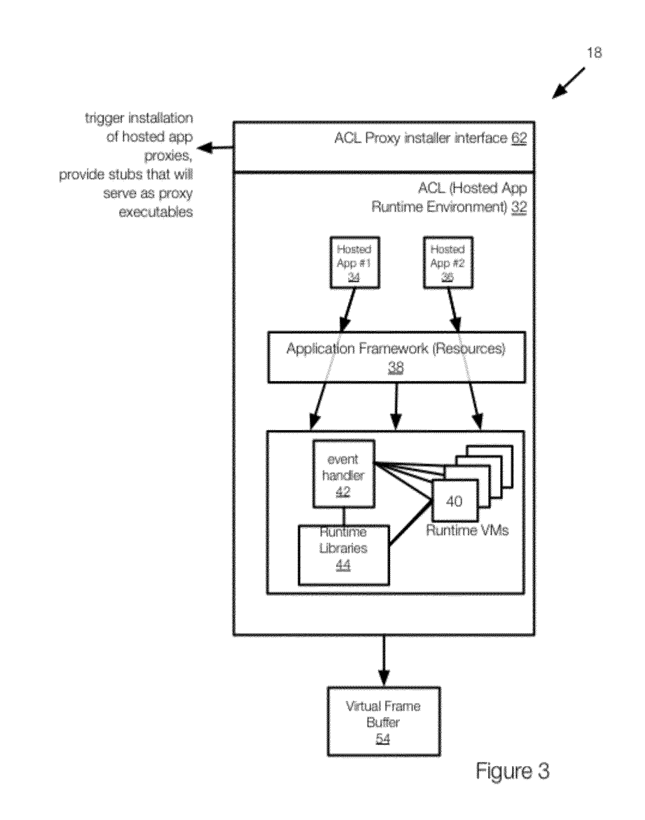

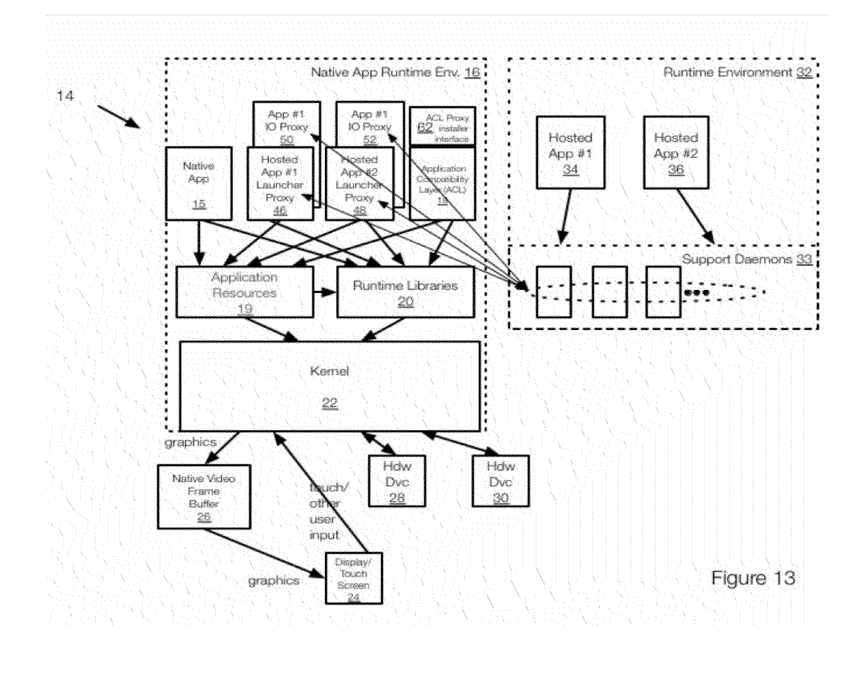

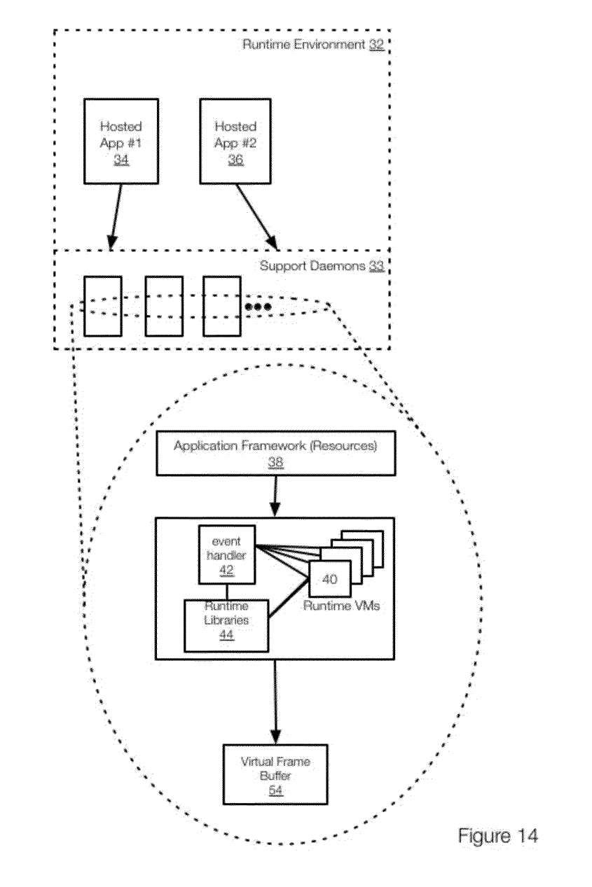

A native software application 18, referred to, here, without intent of limitation, as the “Applications Compatibility Layer” or “ACL”, executing within the one or more native runtime environments 16, defines one or more hosted runtime environments within which hosted software applications are executing. In this regard, the application 18 can execute code comprising those hosted runtime environment(s) 32 or portions thereof (e.g., the virtual machines that make up those hosted runtime environment(s) 32). Alternatively, or in addition, the application 18 can effect the installation, instantiation and/or invocation of processes and, more typically, for example, daemons, that make up those environments 32 or portions thereof. The former approach is illustrated in FIGS. 2-3; the latter is illustrated in FIGS. 13-14.

Each such hosted software application has instructions for execution under a hosted operating system that differs from the native operating system.

Native software applications 46-52 are proxies of hosted software applications 34, 36 that afford them (the hosted software applications) access to resources of the native operating system 14 and native runtime environments 16, as well as of the hardware resources of the device 10. Particularly, in the illustrated embodiment, each hosted software application executing in hosted runtime environment 32 has two corresponding proxies executing in the executing in native runtime environment 16: a launch proxy and an IO proxy. Here, the proxies of hosted software application 34 are launch proxy 46 and IO proxy 50. The proxies of hosted software application 36 are launch proxy 48 and IO proxy 52. Although, both launch and IO proxies are used in the illustrated embodiment, in other embodiments hosted software applications may have corresponding proxies of only one type (e.g., IO or launch) or otherwise. For example, in other embodiments, still more proxies may be provided for each hosted application, and, yet, in still other embodiments, the functions of multiple such proxies may be combined into a single proxy—all without deviating from the spirit hereof.

Hosted Runtime Environment(s)

The hosted operating system can be, for example, a Linux-based operating system, such as, by way of nonlimiting example, an Android-based operating system. The native operating system 14 can likewise be, for example, a Linux-based and/or Android-based operating system, albeit, of a different “flavor” than that of the hosted operating system. By way of more particular example, where the native operating system 14 comprises one of the aforementioned Tizen, WebOS, Linux operating systems (as adapted in accord with the teachings hereof), by way of nonlimiting example, the hosted operating system can comprise a “flavor” of the commercially available Android operating system (as adapted in accord with the teachings hereof), again, by way of nonlimiting example.

FIG. 3 depicts the one or more hosted runtime environments 32 defined by the native software application 18 (or ACL) for execution of hosted software applications 34, 36 in the device 10 according to some practices of the invention. The illustrated hosted runtime environment 32 is of the type known in the art (as adapted in accord with the teachings hereof) within which software applications having instructions for execution under the hosted operating system (i.e., hosted software applications) are built and intended to be executed.

The hosted runtime environment(s) 32 may comprise one or more virtual machines or otherwise, as is conventional in the art (as adapted in accord with the teachings hereof), depending on the type of the hosted operating system and the specifics of its implementation within the runtime environments 32. Illustrated hosted runtime environment 32 is intended for executing Android-based software applications 34, 36 (though, other embodiments may be intended for executing applications designed and built for other operating systems) and includes, by way of non-limiting example, a resource framework 38, virtual machines (VMs) 40, event handler 42 and run-time libraries 44, all by way of non-limiting example and all of the type known in the art, as adapted in accord with the teachings hereof.

The illustrated runtime environment 32 does not include a kernel per se (as might normally be included, for example, in the runtime environment of a Linux-/Android-based operating system) in the sense of running operations in a protected, kernel space of the type known in the art. Instead, some such operations (e.g., operations that might normally be included, for example, in the kernel of a Linux-/Android-based operating system) are executed in user space.

By way of example are those kernel space operations relied upon by the resource framework 38, virtual machines (VMs) 36, event handler 42, run-time libraries 44, and/or other components of the runtime environment 32 to load graphics to a frame buffer for presentation on a display. Rather than executing in a kernel of hosted runtime environment 32, in the illustrated embodiment those operations are elevated to user space and are employed to load such graphics to a “virtual” frame buffer 54, which (as discussed below) is shared with the native runtime environment 16 and the applications executing there—particularly, the I/O proxy applications 50, 52.

The execution of other such kernel-space operations is avoided by passing-off to native operating system 14 and its runtime environment 16 operations and, more broadly, functions required for execution of hosted software applications 34, 36 that would otherwise be performed within the runtime environment 32 and, specifically, for example by a kernel thereof.

Such passing-off, in the illustrated embodiment, is effected, for example, by the resource framework 38, virtual machines (VMs) 36, event handler 42, run-time libraries 44, and/or other components of the runtime environment 32, which communicate with and/or otherwise rely on the native software application proxies 46-52 (executing in runtime environment 16) of hosted software applications 34, 36 to perform such functions or alternates thereof.

A further appreciation of the foregoing maybe attained through the discussion that follows and elsewhere herein.

Native and Hosted Software Application Installation

Native software applications, e.g., 15 and 18, are installed (upon direction of the user or otherwise) on device 10 and, more particularly, for execution within native runtime environments 16, in the conventional manner of the art for installations of apps within operating systems of the type of operating system 14. Such installation typically involves cooperative action of hosted operating system 14 and the runtime environments 16 executing an “installer” app (not shown) of the type conventional to OS 14 and typically includes unpacking, from an applications package file (e.g., downloaded from a developer site or otherwise), the to-be-installed application's executable file, icon file, other support files, etc., and storing those to designated locations in static storage (MEM) on device 10, again, in the conventional manner known in the art.

Hosted software applications 34, 36 are installed (upon direction of the user or otherwise) under control of ACL 18 for execution under hosted runtime environments 32. To that end, the ACL 18 can utilize an installer app the type conventional to the hosted operating system, albeit, modified to unpack from the application package files, or otherwise, the to-be-installed application's executable file, icon file, other support files, etc., to suitable locations in static storage (MEM) on device 10, e.g., locations dictated by native operating system 14, yet, consistent with the hosted operating system, or otherwise.

Unlike other native software applications, e.g., 15 and 18, the native software applications 46-52 that are proxies of a hosted software application 34, 36 are installed, by request from ACL 18 to native operating system 14, in connection with the installation by ACL 18 of each respective hosted software application. Each such proxy 46-52 is installed by the native operating system 14 in the conventional manner, albeit, from application package files (or otherwise) generated by ACL's 18 proxy installer interface 62, which triggers installation of those proxies.

Those package files can include, in lieu of the respective hosted software application 34, 36 executable, a “stub” executable suitable for
i. execution under native operating system 14 and, particularly, within native runtime environments 16,
ii. effecting the functions discussed below (and elsewhere herein) attributable to the launch proxies and the IO proxies, respectively.

Those package files can also include icon files that are identical to or variants of those originally supplied with the application package files (or otherwise) for the respective hosted software applications 34, 36. Although, in the illustrated embodiment, multiple proxies may be associated with each hosted software application, only a single icon is associated with the proxies as displayed on the graphical desktop, e.g., of FIG. 1A—and, more particularly, an icon may be associated with only a single one of the multiple proxies that are associated with a given hosted software application.

Hosted Execution Environment Integration

As illustrated in FIGS. 2-3, in some embodiments, the native application 18 executes the code that makes up the hosted runtime environment(s) 32, e.g., the code comprising the substituent resource frameworks 38, virtual machines 40, event handlers 42, run-time libraries 44, and/or other components of the environments 32. Execution of that code can spawn threads or processes but, typically, they execute within the context of the application 18 itself.

In the foregoing regards, application 18 can be likened to an emulator; although that analogy break downs, for example, when the roles of the native applications that serve as proxies 50, 52 are taken into account as discussed herein.

The analogy also break downs in embodiments where the instruction set utilized by the hosted application 34 is suitable for execution on the CPU of device 10 (or, put another way, where the native and hosted operating systems are both targeted to the same CPU, i.e., that provided by device 10). In such embodiments, execution of the hosted software application 34 instructions can be carried out directly by the CPU of device (and not, for example, merely emulated by native software application 18)—though, the handling of interrupts generated by and/or calls made in the course of such execution may be handled by the hosted runtime environments 32 (whether, themselves, executed by application 18 or otherwise).

Conversely, in other embodiments, application 18 can, instead, effect the installation, instantiation and/or invocation of processes—and, more typically, for example, daemons—that execute outside the context of application 18 and that provide services making up those environments 32 without itself executing the code that makes them up. This is illustrated in FIGS. 13-14, which parallel FIGS. 2-3 and which use like reference numbers to identify like elements, showing daemons (or other background processes) 33 which provide those services.

In some such embodiments, when native software application 18 is installed on device 10 under native operating system 14, the application 18 itself, its installation package, or other functionality (e.g., the native operating system 14) concurrently installs, instantiates and invokes daemons 33 on device 10, e.g., for execution as persistent background processes that auto-load with each reboot of device 10 and/or operating system 14. In related embodiments, native software application 18 effects installation, instantiation and invocation of such persistent/auto-loading daemons 33 when the application 18 is executed for a first time by the user of device 10. In yet other embodiments, application 18 installs, instantiates and/or invokes the daemons 33 on a one-time or short-term basis, persisting those daemons for only so long as application 18 is itself executing on device 10. Still other embodiments utilize other mechanisms for installing, instantiating and/or invoking daemons 33, e.g., under control of application 18 or otherwise.

Of course, it will be appreciated that, although, multiple daemons 33 are shown in the drawing, in some embodiments other numbers of daemons (for example, just one) may be utilized. And, although, the daemons may be allocated on a per service basis in the illustrated embodiment, in other embodiments they may be allocated on a per hosted application-basis, a per proxy basis, or otherwise.

In yet other embodiments, application 18 takes a mix of the approaches discussed above, e.g., executing code that makes up some portions of the environments 32 (e.g., like shown in FIGS. 2-3, while installing, instantiating and/or invoking services/process to provide services making up other portions of those environments (e.g., like shown in FIGS. 13-14).

Multi-Operating System Mobile and Other Computing Devices

The computing device 10 supports the seamless execution of applications of multiple operating systems—or, put another way, it “merges” the user experience so that applications executed in the hosted runtime environment appear, to the user, as if they are executing within the native operating system 14.

Thus, for example, application windows representing execution of the hosted software applications are presented to the user without interfering with the status bar that forms part of the “desktop” generated as part of the overall graphical user interface by the native operating system 14 and/or native runtime environment 16, thus, making the hosted software applications appear similar to native software applications. This is shown, by way of example, in FIGS. 1A-1C.

Referring to FIG. 1A, the native operating system 14 drives the computing device to display, on display/touch screen 24, a graphical desktop with icons 58 representing applications that can be selected for launch or other activation by the user of the device 10. In the illustrated embodiment, these can be native software applications, e.g., 15, and hosted software applications, e.g., 34,36.

That desktop display includes a status bar 56 of the type conventional in the art—and, particularly, conventional to native operating system 14 (although, some embodiments may vary in this regard). Here, that status bar 56 indicates the current date/time, carrier conductivity signal strength (e.g., Wi-Fi, cellular, etc.), active apps, and so forth, though, in other embodiments, it may indicate other things.

Referring to FIG. 1B, when a native software application, e.g. 15, is activated by the operating system 14 and/or runtime environments 16 in response to user selection, the application window 60 generated for it by the native runtime environment 16 (reflecting execution of the application) for presentation on the screen 24 occupies that screen along with the status bar 56—here, particularly, with the status bar 56 on the top fraction of the screen and the application window 60 on the remainder. Put another way, the operating system 14 and/or runtime environments 16 do not overwrite the status bar 56 with the applications window 60. (Of course, it will be appreciated that this is the default mode of operation of the operating system 14 and/or runtime environments 16, and that in other modes, e.g., so called “full screen” modes, the application window 60 may occupy the entirety of the screen).

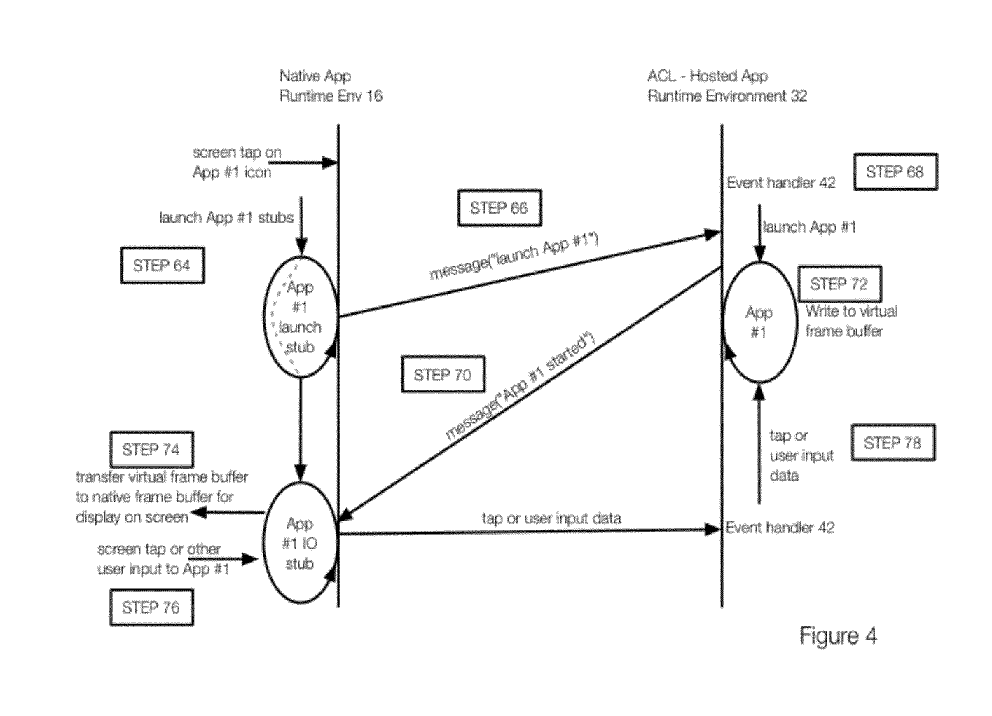

Referring to FIG. 1C, likewise, in the illustrated embodiment, when a hosted software application 34, 36 is activated, the application window generated for it (reflecting execution in the hosted runtime environments 32) is presented identically on the screen 24 as that of a native software application—that is, it is presented without overwriting the status bar 56 (e.g., at least when displaying in default mode). In the illustrated embodiment, this is accomplished via operation of IO proxies as discussed below in connection with FIG. 4.

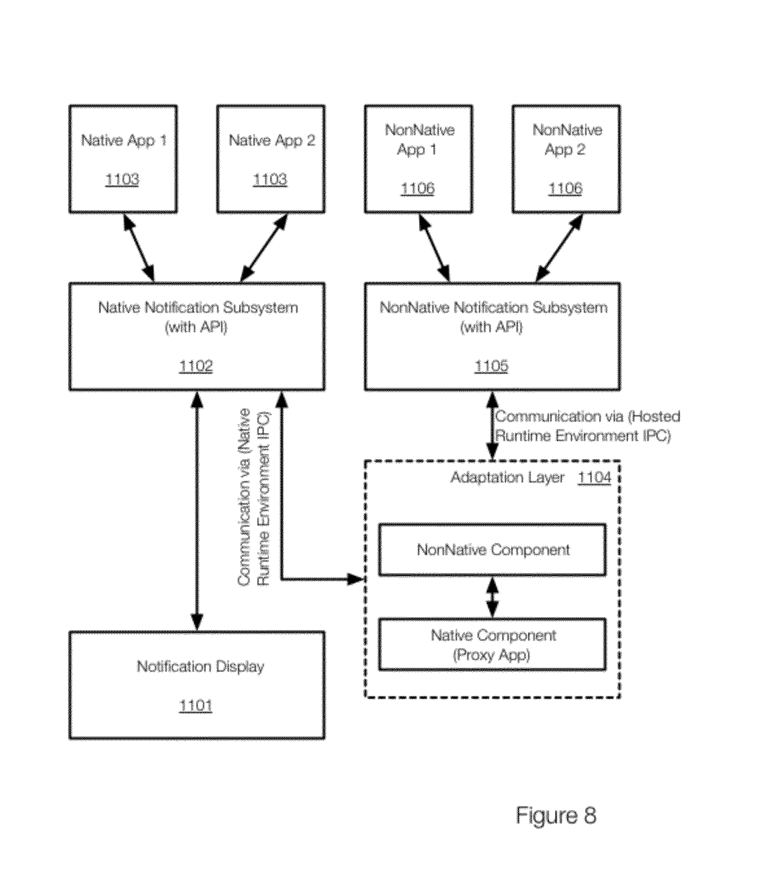

Another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16, e.g., as shown in FIGS. 8-12 and discussed below in connection therewith.

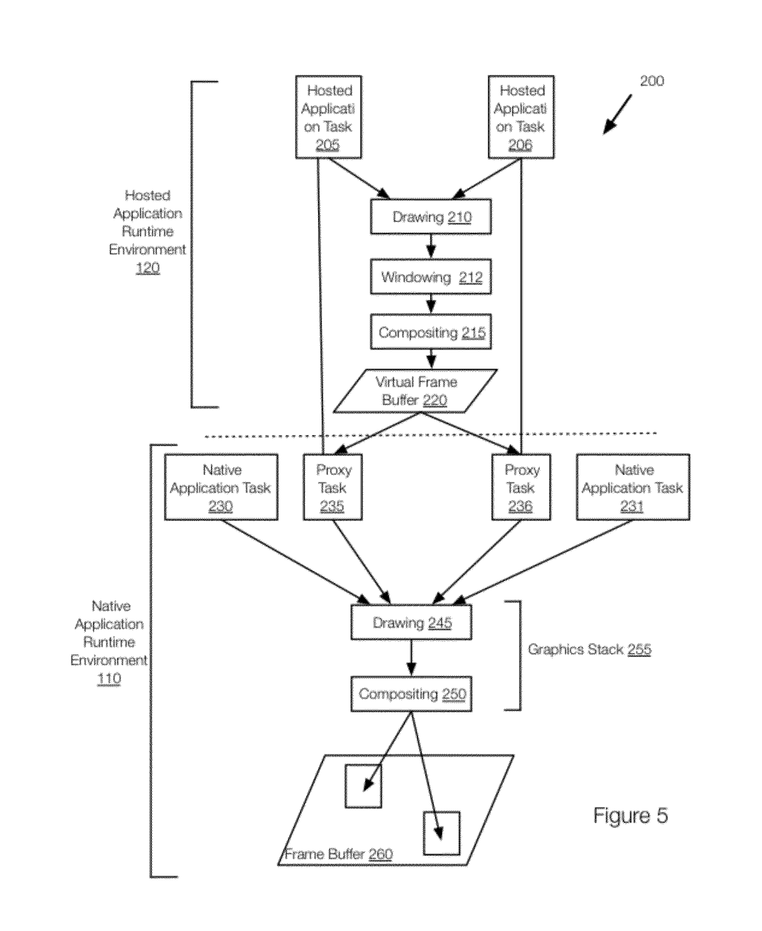

Still another example is the consistent activation of running software applications in response to user replies to notifications (and otherwise), whether they are native applications, e.g., 15, or hosted software applications 34, 36, e.g., as shown in FIGS. 5-7 and discussed below in connection therewith.

Some of the mechanisms for effecting the foregoing, e.g., as noted above, involve the use of natively executing proxies 46-52 to afford hosted software applications executing in the hosted runtime environments 32 access to resources of the native operating system 14 and native runtime environments 16, as well as of the hardware resources of the device 10.

Still other examples and the mechanisms by which they are implemented will be evident to those skilled in the art from the discussion that follows, the drawings, and elsewhere herein.

Hosted Application Display in Multi-Operating System Mobile and Other Computing Devices

A further understanding of the operation of device 10 in these regards may be appreciated by reference to FIG. 4, which depicts the interaction of the components discussed above in launching an exemplary hosted software application 34 (here, labelled “App 1”) in hosted runtime environments 32 based on user interaction with that app's launch proxy 46 (here, labelled “App #1 Launch Stub”) executing in native runtime environments 16, displaying an application window representing operation of hosted software application 34 via that app's IO proxy 50 (here, labelled “App #1 IO Stub”), and transmitting user input from that proxy 50 back to the app 34.

Prior to illustrated step 64, native runtime environments 16 (and/or native operating system 14) present on the above-described graphical desktop (see, e.g., FIG. 1A) icons 58 representing native and hosted software applications that can be selected for launch or other activation by the user of the device 10. As noted above, those icons are provided to native runtime environments 16 and/or native operating system 14 in connection with installation of the respective apps.

As per convention of operating systems of the type of native operating system 14, the native software application that is launch proxy 46 is launched by native runtime environments 16 and/or native operating system 14 upon its selection for activation by the user. See, step 64. Proxy 50 can be simultaneously launched by native runtime environments 16 and/or native operating system 14; alternatively, proxy 50 can be launched by proxy 46 upon its launch. Id.

Upon launch (or other notification of activation from native runtime environments 16 and/or native operating system 14), proxy 46 effects activation of corresponding hosted software application 34. See, step 66.

In the illustrated embodiment, proxy 46 does this by transmitting a launch message to the event handler 42 that forms part of the hosted runtime environments 32 and that is common to the one or more hosted software applications 34, 36 (e.g., in that it is the common, shared recipient of system level-events, such as user input to the hardware interface, which events it distributes to appropriate hosted applications or other software executing in the hosted runtime environments 32 or provided as part of the hosted operating system). The launch message, which can be delivered to event handler 42 by proxy 46 using any convention mechanism for inter process communication (IPC), e.g., APIs, mailboxes, etc., includes an identifier of the proxy 46 and/or its corresponding hosted software application 34, as well as any other information required by the hosted operating system and/or hosted runtime environments 32 to effect launch of a hosted software application.

In step 68, the event handler 42 launches the hosted software application 34 in the conventional manner required of hosted operating system and/or the hosted runtime environments 32. Put more simply, that app 34 is launched as if it had been selected by the user of device 10 directly.

Following launch of hosted software application 34, event handler 42 uses IPC, e.g., as described above, to signal that hosted software application 34 has begun execution and, more aptly, to insure launch (if not already effected) and activation of proxy application 50 with the native runtime environments 16. See, step 70.

Following launch, hosted software application 34 runs in the conventional manner within hosted runtime environments 32, generating such interrupts and makes such calls to the hosted resource framework 38, hosted event handler 42 and run-time libraries 44, all by way of non-limiting example, as it would otherwise make if it were installed on a device executing a single operating system of the type of the hosted operating system. This is advantageous in that it does not require special recoding (i.e., “porting”) of the hosted software application 34 by the developer or publisher thereof in order to make it possible to run in the multi-operating system environment of device 10.

Hosted resource framework 38, hosted event handler 42 and run-time libraries 44, and the other components of hosted runtime environments 32 respond to such interrupts and calls in the conventional manner known of operating systems of the type of hosted operating system, except insofar as evident from the teachings herein.

Thus, for example, as noted above, some such operations (e.g., those for loading frame buffers) of the type that might normally be executed in a privileged kernel space by hosted runtime environments 32 are, instead, executed in user space. And, other such operations or, more broadly, functions are passed-off to native operating system 14 and its runtime environment 16, e.g., via the proxies 46-52.

By way of example, in lieu of loading an actual frame buffer with graphics defining an applications window representing execution of the hosted software application 34, the hosted runtime environment 32 loads the virtual frame buffer 54 with such graphics. See, step 72. The hosted runtime environment 32 effects this through use of the windowing subsystem that forms part of the hosted runtime environment 32 and that is common to the one or more hosted software applications 34, 36 (e.g., in that it is the common, shared system used by the hosted software applications for generating applications windows for display to the user of device 10.)

The IO proxy 50 of hosted software application 34 effects presentation on screen 24 of the applications windows generated for application 34 by hosted runtime environments 32, e.g., in the manner shown in FIG. 1C and discussed in connection therewith above. See, step 74. IO proxy 50 does this by transferring the graphics defining that applications window from virtual frame buffer 54 to the native frame buffer 26, e.g., using an API provided by native runtime environments 16 for such purpose or otherwise. Although in some embodiments, the hosted runtime environments 32 utilizes messaging to alert IO proxy 50 of the need for effecting such a transfer, e.g., when the window subsystem of hosted runtime environments 32 has generated an updated applications window for hosted software application 34, when hosted software application 34 becomes the active (or foreground) app in hosted runtime environments 32, or otherwise, in other embodiments IO proxy 50 effects such transfers on its own accord on a periodic basis or otherwise.

User/Hosted Application Interaction in Multi-Operating System Mobile and Other Computing Devices

IO proxy 50 utilizes a mechanism paralleling that discussed above in connection with steps 64-68 in order to transmit taps and other input made by the user to device 10 and specifically, for example, to display/touch screen 24, a keyboard, trackball, touch stick, other user input devices. In this regard, a common event handler (not shown) or other functionality of native runtime environments 16 notifies applications executing within them, including the IO proxies 50, 52, of user input made with respect to them via the touch screen 24 or those other input devices. Such notifications are made in the conventional manner known in the art of operating systems of the type of native operating system 14, as adapted in accord with the teachings hereof.

When IO proxy 50 receives such a notification, it transmits information with respect thereto to its corresponding hosted software application 34 via event handler 42, e.g., in a manner similar to that discussed above in connection with step 66. See, step 76. That information, which can be delivered to event handler 42 by IO proxy 50 using any conventional IPC mechanism, can include and identifier of the IO proxy 50 and/or its corresponding hosted software application 34, an identifier of the device to which input was made, the type of input, and relevant information with respect thereto (e.g., location, time, duration and type of touch, key tapped, pressure on pointer, etc.). That information is received by event handler 42 and applied to the corresponding hosted software application 34 in the conventional manner required of hosted operating system and/or the hosted runtime environments 32, e.g., as if the touch or other user input had been made directly to hosted software application 34. See, step 78.

Hosted Application Utilization of Native Operating System Proxies in Multi-Operating System Mobile and Other Computing Devices

As discussed above and elsewhere herein, the respective hosted software applications (e.g., 34) utilize their corresponding proxies (e.g., 46) to perform the following, by way of nonlimiting example:
present (via operation of native operating system 14) icons on the native operating system 14 graphical desktop of display/touch screen 24 for selection by the user;
present on display/screen 24 applications windows generated by the respective hosted software applications;
to relay to the hosted runtime environments 32 launch and activation requests, e.g., signaled by the user via the display/touch screen 24 and native operating system 14;
to relay to the hosted runtime environments 32 taps and other input made by the user to device 10 and specifically, for example, to display/touch screen 24, a keyboard, trackball, touch stick, other user input devices;
to effect bringing the hosted software applications to the virtual foreground in the hosted runtime environments 32.

The hosted software applications can similarly use proxies executing in the native runtime environments 16—e.g., proxies 46-52 or otherwise—for access to other resources of the native operating system 14 and native runtime environments 16, as well as of the hardware resources of the device 10

Thus, for example, hosted software applications, e.g., 34, that utilize a still, video or other camera provided with device 10 (e.g., natively or otherwise) can access and/or alter pictures, movies of other image(s) and/or related data generated by that camera and/or by associated application resources 19 and/or runtime libraries 20 (and, more generally, by native runtime environments 16) through use of the IO proxy 50 or another proxy, e.g., associated with that same hosted software application.

To this end, paralleling the actions discussed in connection with Step 72, when a camera subsystem that forms part of the hosted runtime environment 32 (e.g., and that is common to the one or more hosted software applications) is invoked by a hosted software application, that subsystem loads a buffer and/or messages the natively-executing proxy corresponding to that hosted software application in order to identify primitives to be executed within the native runtime environments 16. Paralleling the actions discussed in Step 74, the proxy can utilize a camera subsystem of the native runtime environments 16 (or other functionality) to execute those primitives. The proxy can, them, reload that or another buffer or otherwise generate a message with results of such execution and can pass that back to the hosted runtime environments 32 via its event handler 42, e.g., paralleling the actions discussed above in connection with Step 76. The camera subsystem of the hosted runtime environments 32 responds to notification from that event handler 42 by returning to the requisite image(s) and/or other information to the hosted software application that invoked that subsystem.

By way of further nonlimiting example it will be appreciated that natively-executing proxies can be utilized by hosted software applications to accesses a telephony-related services and/or related data provided by device 10 and/or its native runtime environments 16. This includes not only use of the so-called telephone function (i.e., to make and receive calls), but also telephone logs, address books and other contact information.

Coordination of Foreground Application Tasks in Multi-Operating System Mobile and Other Computing Devices

Native runtime environments 16 responds to activation of an executing native application, e.g., via user selection of the corresponding applications window or icon on the desktop of display 24, or otherwise, by bringing that applications window to the foreground and making it the active task with which the user interacts (and to which user input is directed). Similar functionality is provided by the event handler 42 of hosted runtime environments 32, albeit with respect to executing hosted software applications, with respect to a virtual desktop residing on virtual frame buffer 54, and with respect to virtual user input devices.

In order to more fully merge the user experience so that applications executed in the hosted runtime environments 32 appear, to the user, as if they are executing within the native operating system 14, when IO proxy 50 is brought to the foreground of the graphical user interface presented on the aforementioned desktop by the windowing subsystem of native runtime environments 16 (e.g., as a result of a user tap on the application window for IO proxy 50, as a result of issuance of a notification with respect to that application or otherwise), that IO proxy 50 effects making the corresponding hosted software application 34 active within the one or more hosted runtime environments 32, as if it had been brought to the foreground in them.

An understanding of how this is effected in the illustrated embodiment may be attained by reference to the discussion that follows, in which:
the term “task” is used in place of the term “application”;
the term “interactive task” is used in reference to an application for which an applications window is generated as part of the graphical user interface of the respective operating system and/or runtime environment reflecting execution that application;
the term “foreground task” is used in reference to an application with which the user of device 10 is currently interacting;
the term “simple interactive task” refers to an application running in one process;
the term “complex interactive task” refers to an application running in more than one process; and
although a differing elemental numbering scheme is used, like names are used for like components discussed above and shown in FIGS. 1-4.

The teachings below provide for managing tasks (i.e., applications) where the designation of a foreground task in the hosted application runtime environment 32 is independent of the designation of a foreground task in the native application runtime environment 16, and where tasks in the hosted application runtime environment 32 may (or may not) span multiple processes.

With reference to FIG. 5, in accordance with the illustrated embodiment of the invention, native application tasks in operating systems with simple task models (such as native operating system 105) are each associated with a single process. Interactive native application tasks 230, 231 are further differentiated from non-interactive tasks (not shown) by their utilization of the graphics stack 255 of the native application runtime environment 110. The graphics stack 255, comprised of drawing module 245 and compositing module 250, updates the contents of the native frame buffer 260 with the visual portions of the foreground task for display to a user via display/touch screen 24.

Hosted (or non-native) application tasks 205, 206 reside within the hosted application runtime environment 120. If the hosted application runtime environment 120 employs a different task model than the native operating system 105, each hosted application task 205, 206 is associated with a proxy (or client) task 235, 236, respectively. The proxy tasks 235, 236 reside within the native application runtime environment 110 along with the native application tasks 230, 231, and are managed by the same native task management system in the native application runtime environment 110 as the native application tasks 230, 231.

The proxy tasks 235, 236 monitor the state (foreground or background) of the hosted application tasks 205, 206, and enable the hosted application tasks 205, 206 to be fully functional within the device 100, despite the differences between the application runtime environments 110 and 120. In the illustrated embodiment, proxy tasks are created when the hosted tasks are created, but this is not a limitation of the invention.

Hosted application runtime environment 120 comprises a drawing module 210, a windowing module 212, and a compositing module 215, that together provide the visual portions of the hosted application tasks 230, 231 to the virtual frame (or screen) buffer 220.

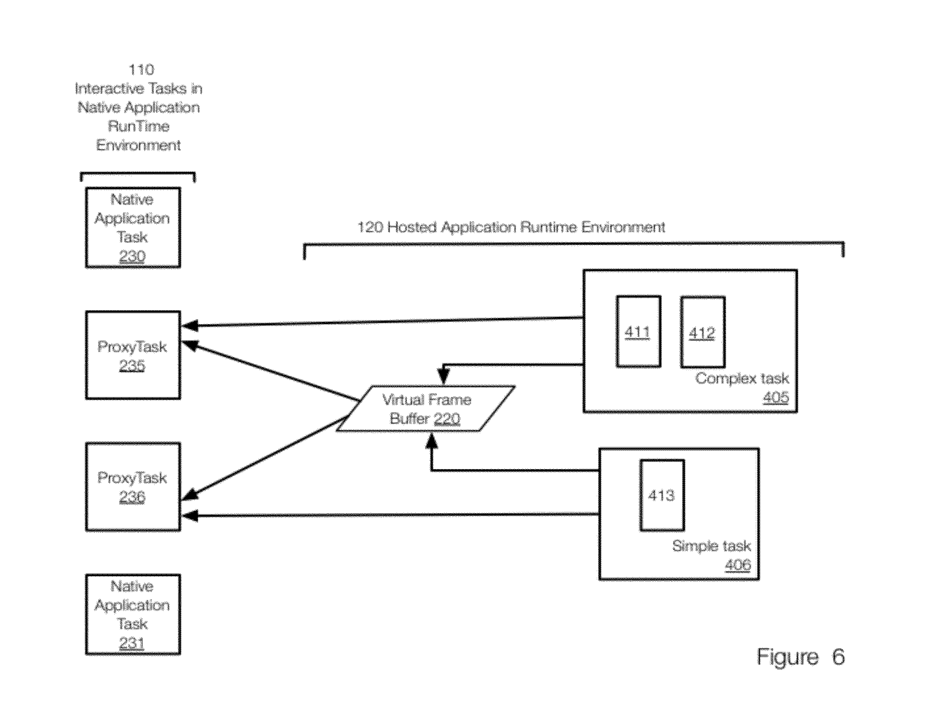

As shown in FIG. 6, hosted application runtime environment 120 further comprises a task 405 operating in accord with the complex task model and having two processes 411, 412, and a task 406 operating in accord with the simple task model and having one process 413). Regardless, in the illustrated embodiment, each of the tasks 405, 406 is associated with one proxy (or client) task 235, 236 respectively, and also associated with one hosted application 205, 206 respectively.

Together, the proxy (or client) tasks 235, 236, the task models 405, 406, the hosted system of drawing 210, windowing 212, and compositing 215 modules, and the virtual frame (or screen) buffer 220, provide the following functions: (i) enabling the hosted application tasks 205, 206 to run as background tasks within the native application runtime environment 110; (ii) enabling the hosted application runtime environment's 120 foreground status to be abstracted from the operation and semantics of the task management system in the native application runtime environment 110; and (iii) integrating and coordinating the operation of the hosted application runtime environment 120 and the native application runtime environment 110 such that the user cannot discern any differences between the functioning of the native application tasks 230, 231 and the hosted application tasks 205, 206.

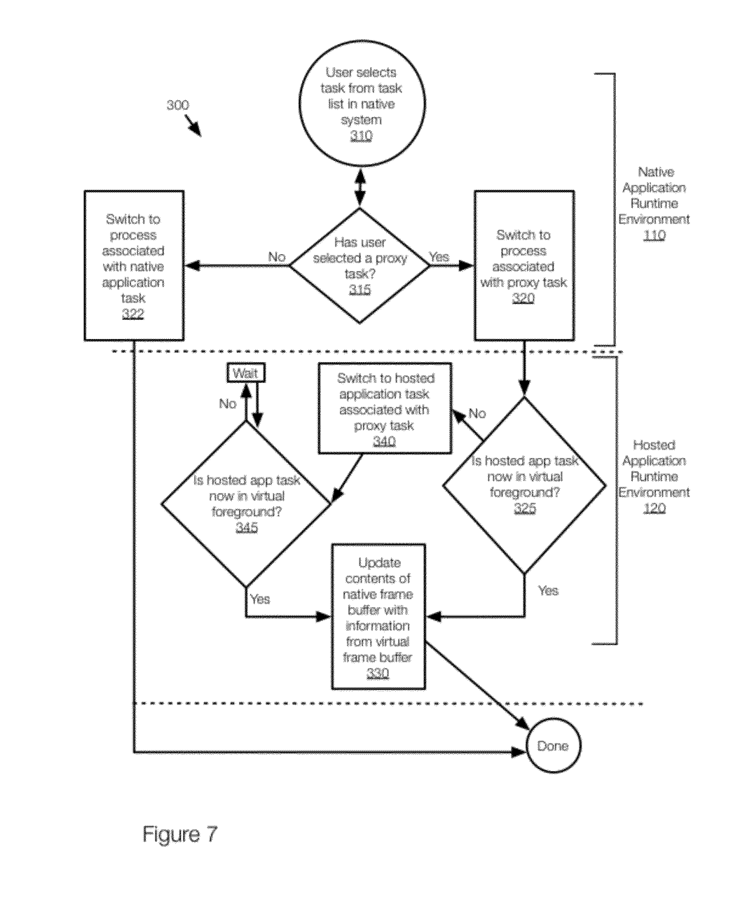

FIG. 7 illustrates the method of switching between interactive tasks and, more particularly, of coordinating foreground/active tasks, as between the native and posted runtime environments, in accordance with a preferred embodiment of the invention. In particular, FIG. 7 illustrates how the task displayed in the virtual frame buffer 220 of the hosted application interface environment 120 is coordinated with its corresponding proxy task and the foreground task of the native application runtime environment 110.

In step 310, the user selects an interactive task from the task list in the native system.

Both native application tasks 230, 231 and proxy tasks 235, 236 (as stated above and shown in FIG. 6, proxy tasks 235, 236 are tasks within the native application runtime environment 230 that act as proxies for hosted application tasks 205, 206 respectively), are available in the task list for selection by the user. At step 315, the method determines whether the user has selected a proxy task or a native application task. Proxy tasks are distinguished from native application tasks by convention. Any property where a value or a string can be modified can be used, by convention, to identify a proxy task. In a preferred embodiment, task names are used to distinguish between proxy tasks and native application tasks, although this is not a limitation of the invention.

If the user selects a native application task (i.e., one of 230, 231) at step 315, the method proceeds to step 322. At step 322, the native application runtime environment 110 switches to the process associated with the selected native application task, and brings the selected native application task to the foreground of the native application runtime environment 110.

Alternatively, if the user selects a proxy task (i.e., one of 235, 236) at step 315, the method proceeds to step 320. At step 320, the native application runtime environment 110 switches to the process associated with the selected proxy task (e.g., as discussed elsewhere herein) and brings the selected proxy task to the foreground of the native application runtime environment 110.

At this point, the task switch has occurred in the native application runtime environment 110, and may need to be propagated to the hosted application runtime environment 120. At step 325, the method determines whether or not the task switch needs to be propagated to the hosted application runtime environment.

At step 325, the method determines whether the hosted application task is in the virtual foreground of the hosted application runtime environment 120. This determination is made using information obtained by the proxy task 235, 236 about the state of the virtual frame buffer 220 in the hosted application runtime environment 120. Specifically, the proxy tasks monitor the state (foreground or background) of the hosted application tasks.

If the hosted application task is in the virtual foreground of the hosted application runtime environment 120, the task switch does not need to be propagated, and the method proceeds to step 330. At step 330, the hosted application task's view of the virtual frame buffer 220 is updated to the native frame buffer 260. At this point, the hosted application task is in the foreground, and the user will be able to view and make use of the user-selected task. The seamless transition allows the user to view the hosted application task 205, 206 as if viewing a native application task.

Referring again to step 325, if the hosted application task is not in the virtual foreground of the hosted application runtime environment 120, the task switch needs to be propagated, and the method proceeds to step 340. At step 340, the hosted application runtime environment 120 switches to the hosted application task 205, 206 associated with the proxy task 235, 236 as described in step 320.

At step 345, the method determines whether the hosted application task 205, 206 is now in the virtual foreground of the hosted application runtime environment 120. If the hosted application task is not in virtual foreground of the hosted application runtime environment 120, the method waits until the hosted application task moves to the virtual foreground of the hosted application runtime environment 120. At this point, the method proceeds to step 330, as described above.

Notification and Reply Adaptation for Hosted Applications in Multi-Operating System Mobile and Other Computing Devices

As noted above, another example of the illustrated computing device's 10 merging the user experience so that applications executed in the hosted runtime environment appear, to the user, as if they are executing within the native operating system 14 is the use of a common notification mechanism, e.g., that of the native operating system 14 and/or runtime environments 16.

An understanding of how this is effected may be attained by reference to the discussion that follows, in which
It will be appreciated that, as a general matter of background, some computer operating systems have notification systems, where applications native to those operating systems post notifications. Users can interact with those notifications, and the interactions are conveyed to the applications that posted those notifications. Unlike applications, notification systems are singletons—there is one per (operating) system;
In the illustrated embodiment, the foregoing is likewise true of the native operating system 14 and, more particularly, of the native runtime environment 16—there is a single notification subsystem that is common to all executing native software applications;
In the illustrated embodiment, the foregoing is likewise true of the hosted operating system and, more particularly, of the hosted runtime environments 32—there is a single notification subsystem that is common to all executing hosted software applications;
The native and hosted operating systems are assumed to have diverse implementations of notification systems: Each might have a different set of standard prompts, visual indicators, and interprocess messages, on different interprocess message systems, used to notify applications of user interactions with notifications;
It is assumed that it would be confusing to the user of device 10 if notifications were presented from two different notification systems, e.g., some from the notification subsystem of the native operating system and some from the notification subsystem of the hosted operating system;
Although a differing elemental numbering scheme is used, like names are used for like components discussed above and shown in FIGS. 1-7

Described below is a mechanism for enabling hosted applications to use and interact with native system notification subsystems.

Referring to FIG. 8, native operating system 14 has a notification subsystem 1102 that provides a visual display of notifications 1101. Applications 1103 post notifications, using an API of subsystem, 1102, and, optionally, can interact with notifications by specifying that they be notified of touches and other user actions through that API, which may use inter-process communication to convey the information about interactions to the application.

Similarly, hosted runtime environments 32 provides a notification subsystem 1105 that is employed by hosted (nonnative) apps 1106. Those applications post notifications, using an API of subsystem 1105, and, optionally, normally interact with notifications by specifying that they be notified of touches and other user actions through that API, which may use inter-process communication to convey the information about interactions to the application.

When a runtime environment for applications designed for a different operating system, or a cross-platform runtime environment that integrates with native-environment notifications is added to and operating system, an adaptation layer 1104 can be used to translate notifications between the two systems.

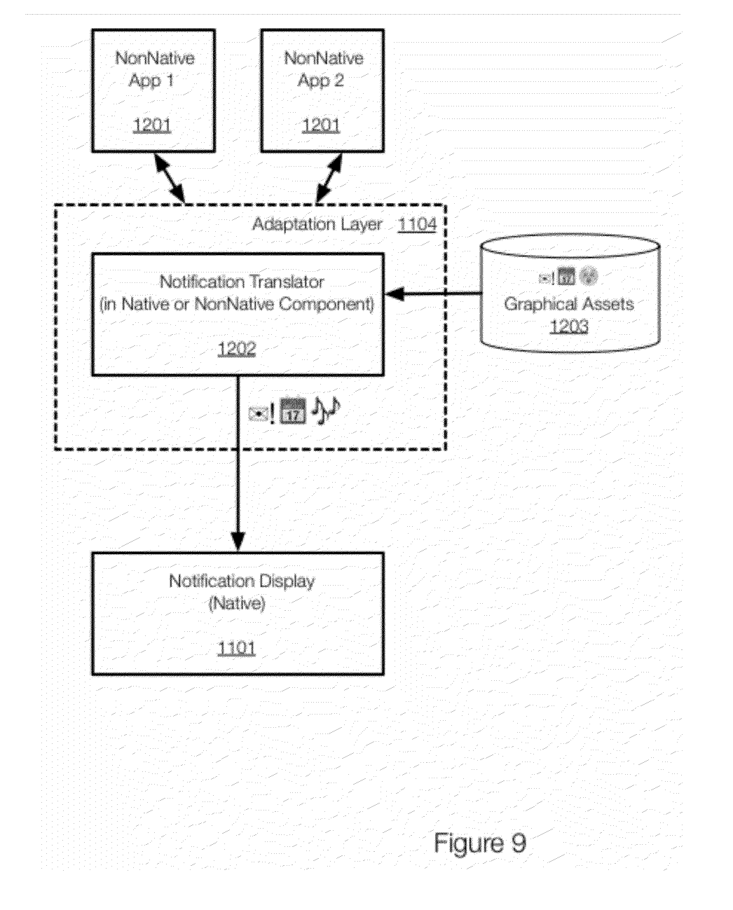

The adaptation layer 1104 provides the following functionality to facilitate adaptation:
The semantics of notification: If, for example, in the native OS, an application is brought to the foreground when a notification is acknowledged by the user, the semantics of this interaction are appropriately translated into actions on tasks in the hosted non-native environment. In the illustrated embodiment, this is effected in a manner like that shown in the FIG. 8 and discussed above in connection with coordinating foreground/active tasks as between the native and hosted runtime environments.
Interfaces: If the native environment uses a different inter-process communications mechanism (IPC) than the hosted non-native environment, the adaptation layer uses the native inter-process communications system and is a proxy for non-native applications to the native environment, and uses the non-native IPC mechanism to communicate with the non-native applications 1106.
Graphical assets: Referring to FIG. 9, if a non-native application 1201 uses the non-native API and thereby the notifications translation layer 1202 of the adaptation layer 1104 to post a notification, and if that notification either lacks a corresponding graphical asset in the native environment, non-native graphical assets 1203 that are included in the hosted runtime environment or non-native applications will be used, and, if necessary, converted to a format displayable in the native environment visual display of notifications 1101. The translation layer 1202 can be implemented in the native component and/or the non-native component of the adaptation layer 1104, as needed.

In the illustrated embodiment, adaptation layer 1104 has a non-native component and a native component which provide the aforementioned functionality. The non-native component has instructions for execution under the hosted operating system and executing on the central processing unit within one of more of the hosted runtime environments. It can communicate With the hosted notification API via the hosted IPC protocol. The native component has instructions for execution under the native operating system and executing on the central processing unit within one of more of the native runtime environments. It can communicate With the native notification API via the native IPC protocol.

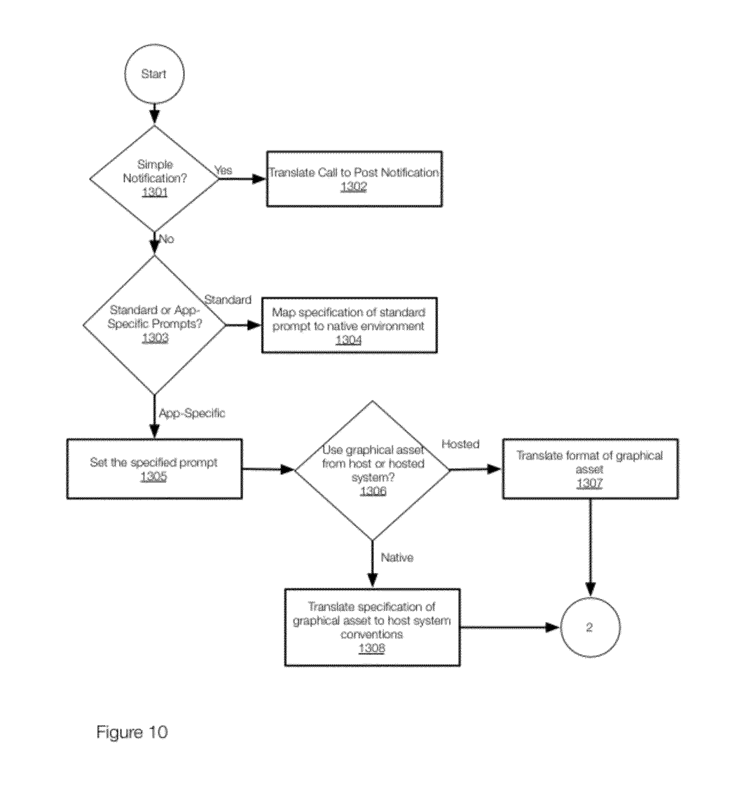

Referring to FIG. 10, when an application 1201 in the hosted, non-native environment posts a notification, the adaptation layer decides if the hosted application is posting a simple notification 1301, without graphical assets, standard prompts that need to be mapped, or a return message. If that is the case, the parameters of the hosted system's (i.e., the hosted operating system's) method are translated to the corresponding parameters in the host system (i.e., the native operating system), and the notification is posted 1302.

If the notification is not simple, then it is determined if the application is posting a notification with standard, predetermined prompt text, or with a prompt that is application-specific 1303. If the notification being posted uses a standard prompt with a counterpart in the host system, the reference to that prompt is mapped to a reference to the counterpart in the host system 1304.

If the prompt is application-specific, or if there is no counterpart to a standard prompt in the host system, the prompt text is passed to the host system to be used in the call to post the notification 1305. If there are graphical assets such as a notification icon in the notification and the asset to be used is from the hosted system 1306 any necessary format conversion is performed 1307. If a graphical asset from the host system is to be used in the notification, the specification or reference to the graphical asset is translated into one used in the host system 1308.

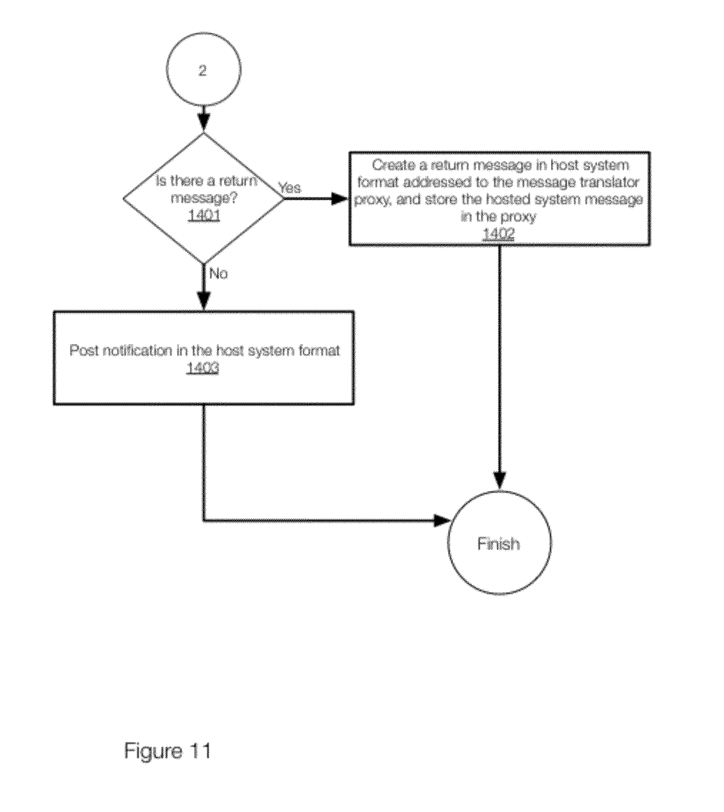

Referring to FIG. 11, if there is a message (in the hosted environment's inter-process communication (IPC) system's format) attached to the notification, to be delivered based on the user's interaction with the notification 1401, that message is registered with a proxy program with an interface to the host system's IPC system, and a message addressed to this proxy program containing a reference to the hosted system's reply message. Now the notification containing:
a prompt text, or a reference to a standard prompt in the host system,
any graphical assets that go with the message or references to host system graphical assets, and,
if present, a reply message that will be delivered to a proxy program that stores the hosted system's reply messages, is posted 1403 to the host system's notification system.

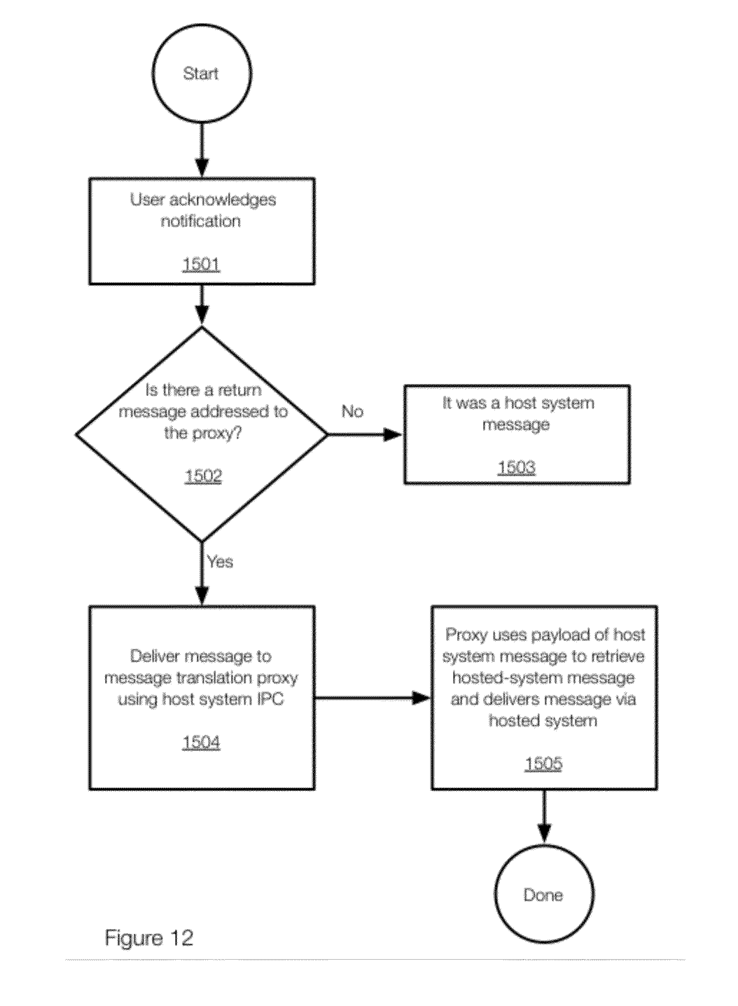

Referring to FIG. 12, if the user interacts with the notification 1501, and if the notification return message is not addressed to the proxy 1502, it is a notification for host system applications, and is processed as usual in the host system 1503. If the return message is addressed to the proxy for return messages, it is delivered to the proxy using the host system's inter-process communications mechanism 1504. The proxy uses the reference contained in the return message to find a return message registered with the proxy when the notification was posted, and this message is delivered to the hosted application, using the hosted system's IPC mechanism, as if it were sent by the hosted system's notification system 1505.

Proxy Applications Running Under Browser

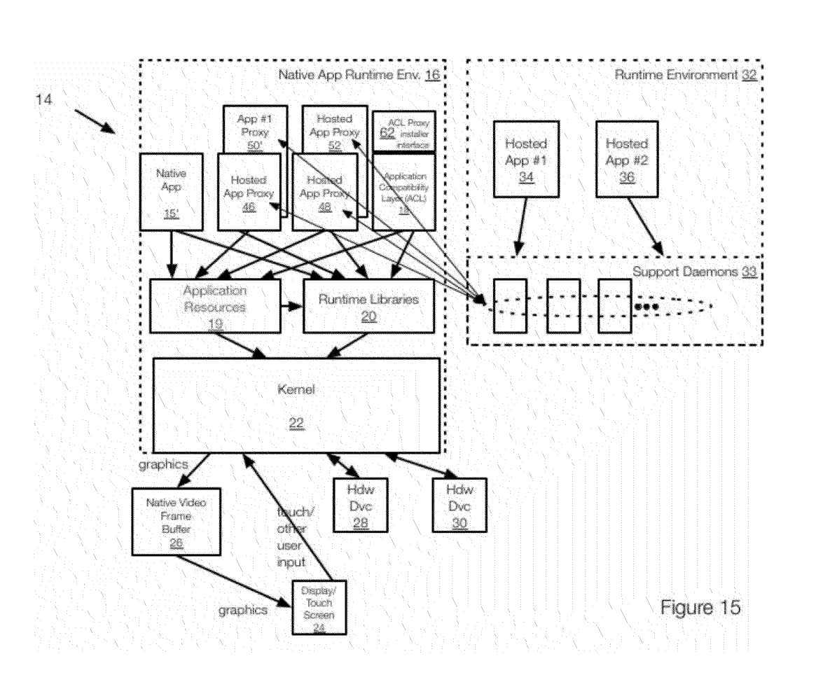

In some embodiments, one or more of the proxy applications 46-52 do not execute under the native operating system 14 as discussed in connection with FIGS. 1-14 but, rather, execute under a browser that, itself, executes under that operating system 14. Such is the case, for example, of computing devices that support native browsers capable of running applications composed of Javascript, HTML5, CSS and/or other browser-compatible instructions sets. Such embodiments of the invention operate as discussed above, as adapted in accord with the comments below and in accord with FIG. 15, which parallels FIGS. 2 and 13 and uses like reference numbers to identify like elements.

Native Runtime Environment(s).

Referring to FIG. 15, element 15′ is a browser software application native to operating system 14. It functions and operates as discussed above with respect to native software application 15, albeit it comprises a browser of the type that defines an execution environment for executing applications in Javascript, HTML5, CSS or other scripting/programming languages common to web apps. Though referred to here and throughout this document as an application, the term “browser” as used herein also refers to layers within a software stack or architecture executing the computing device. An example of such a browser “application” is the Gecko layer of the commercially available on Mozilla's Firefox Operating System (Firefox OS).

Hosted software application 34′ of the illustrated embodiment comprises instructions for execution under the hosted operating system that differs from the application execution environment of browser 15. In other embodiments, only the latter condition holds true; this can be of particular advantage, for example, in the case of computing devices 10 that are configured for user extensibility only via installation of apps within native browsers.

Illustrated proxy 50′ serves the roles of both launch proxy 46 and IO proxy 50 described above with respect to hosted software application 34, albeit here for software application 34′, and it (proxy 50′) operates in the manner described above as to both proxies 46 and 50, albeit as adapted in accord with the teachings below. Unlike proxies 46, 50, however, proxy 50′ operates under a native software application and, more specifically, a native software application browser. In the illustrated embodiment, proxy 50′ comprises HTML5 and/or Javascript instructions suitable for execution under browser 15; although, proxy 50′ of other embodiments may comprises instructions from other programming language instruction sets suitable for execution under browser 15—which itself comprises instructions for execution under the native operating system 14. And, although, only one proxy 50′ is shown in the drawing, it will be appreciated that one or more of the functions ascribed thereto herein may be affected by additional proxies (not shown).

Although only a single proxy app 50′ is shown by way of example in FIG. 15 and described below, it will be appreciated that these teachings apply equally to embodiments in which more (and indeed all) of the proxy apps 46-52 execute under a browser and not under the native operating system 14.

Browser and Hosted Software Application Installation.

Paralleling the discussion, above, in the section entitled “Native and Hosted Software Application Installation,” proxy 50′ is installed by request from ACL 18 to browser 50′ in connection with the installation by ACL 18 of the respective hosted software application—in this case, hosted software application 34. The proxy 50′ is installed by browser 15 in the conventional manner, albeit, from application package files (or otherwise) generated by ACL 18's proxy installer interface 62, which triggers the proxy 50′ installation. As above, those application package files can include icon files that are to be displayed by browser 15 in connection with the proxy 50′ and that match icon files of the corresponding hosted software application 34.

Host App Environment Integration.

In the embodiment of FIG. 15, daemons 33 which provide services that make up host environment 32 are installed and instantiated as persistent, auto-loading processes by native software application 18; although, other embodiments may differ in one or more of these regards.

Multi-Execution Environment Mobile and Other Computing Devices.

Paralleling the discussion, above, in the section entitled “Multi-Operating System Mobile and Other Computing Devices,” the computing device of FIG. 15 merges the user experience so that hosted application 34 executed in the hosted runtime environment appear, to the user, as if it were executing within the browser 15′—as if the hosted application 34 were “native” to the browser.

More generally, device 10 operates with respect to hosted software applications that have proxies executing under the browser 15′ in the same manner as described above in connection hosted software applications that have proxies executing under the native operating system 14, albeit, in the case of hosted applications that have counterpart proxies executing under the browser input from and output to the user is (or, at least, appears to the user to be) via the browser 15, just as with an app natively running under that browser 15′.

Thus, by way of nonlimiting example, analogous to that shown in FIG. 1A, the browser 15 drives the computing device to display, on display/touch screen 24, a graphical “desktop” with icons 58 representing applications that can be selected for launch or other activation by the user of the browser 15. In the illustrated embodiment, these can include hosted software applications that, like application 34′, have a counterpart proxy, like application 50′, installed for execution within that browser 15′. Referring to FIGS. 1B-1C, by way of further example, when hosted software application 34′ is activated in response to user selection (or otherwise) of the proxy 50′, the system generates a window or frame (collectively, “window”) reflecting execution of the application 34′ substantially indistinguishable from that of executing native browser software applications, e.g., vis-a-vis status bars and/or other indicia normally presented by native operating system 14, native runtime environments 16 and/or native browser 15 for launch or other activation.

And, as above, other examples of merging the user experience include
using a common notification mechanism, at least from a user perspective, as between (a) hosted software applications that have proxies executing under the browser 15 and (b) software applications that execute native to the browser 15′;
consistent activation of running software applications in response to user replies to notifications (and otherwise), whether they are hosted software applications that have proxies executing under the browser 15, software applications that execute native to the browser 15′, native software application and/or hosted software application that have proxies executing under the native operating system.

Some of the mechanisms for effecting the foregoing, e.g., as noted above, involve the use of a proxy 50′ to afford hosted software applications executing in the hosted runtime environments 32 access to resources of the native browser 15′, native operating system 14, native runtime environments 16, and/or hardware resources of the device 10.

Hosted Application Display in Multi-Execution Environment Mobile and Other Computing Devices.

Paralleling the discussion, above, in the section entitled “Hosted Application Display in Multi-Operating System Mobile and Other Computing Devices,” interaction of the components discussed above in launching exemplary hosted software application 34′ based on user interaction with that app's launch proxy 50′ executing in browser 15′, in displaying a browser window representing operation of hosted software application 34′ via that app's proxy 50′, and in transmitting user input vis-a-vis that proxy 50′ back to the app 34′, proceeds as generally discussed above in connection FIG. 4 vis-a-vis such interactions between application 34 and proxy 50′, although in the case of hosted application 34′ and proxy 50′:
activations and other input from the user, as well as presentations of icons and other output to the user, are (or, at least, appears to the user to be) via the browser 15′.
communications between the proxy 50′, on the one hand, and the daemons 33 (or other functionality embodying the hosted runtime environment 32 and components thereof) and the hosted software application 34′, on the other hand, is effected via socket-based connections, preferably, between the proxy 50′ and a specified one of the daemons 33, i.e., (which funnels requests to/from the other daemons and/or the hosted software application 34′.
proxy 50′ transmits launch and/or other notifications to event handler 42 via JSON (JavaScript Object Notation) or other messaging protocol—industry-standard, proprietary, or otherwise—using the aforementioned socket-based connections.
operations or, more broadly, functions that are passed-off by the hosted runtime environment 32 to the browser are likewise communicated to the browser 15′ via JSON or other messaging protocol. These can include simple messages of the type VIBRATE{“duration”:10} signaling the browser to generate a vibrate command to the native operating system 14, runtime environment 12 and so forth, as well as more complex messages, including, by way of nonlimiting example, (i) executable scripts, (ii) graphics defining a window of application 34′ contained in the virtual frame buffer 54 to be conveyed by proxy 50′ to browser 15′ for presentation on screen 24.
in lieu of transfer of the virtual frame buffer 54 to the proxy 50′ for presentation as described above, in some embodiments, the windowing subsystem that forms part of the hosted runtime environment 32 accesses resources of the native operating system 14, native runtime environments 16 and/or device 10 to drive the frame buffer directly to video frame buffer 26 and, thereby, to screen 24. In order to merge the user experience as described above, the windowing subsystem effects placement of pixels in the frame buffer 26 so that they fall within a otherwise empty application window or frame displayed by proxy 50′ via browser 15′.

User/Hosted Application Interaction in Multi-Execution Environment Mobile and Other Computing Devices.

Paralleling the discussion, above, in the section entitled “User/Hosted Application Interaction in Multi-Operating System Mobile and Other Computing Devices,” proxy 50′ utilizes the mechanism discussed above in order to transmit taps and other input made by the user to device 10 and specifically, for example, to display/touch screen 24, a keyboard, trackball, touch stick, other user input devices. In this regard, when proxy 50′ is notified (by browser 15′, native runtime environments 16 or otherwise) of user input made with respect to it via the touch screen 24 or those other input devices, it transmits information with respect thereto to its corresponding hosted software application 34′ via JSON or other messaging protocol.

Hosted Application Utilization of Native Browser Proxies in Multi-Execution Environment Mobile and Other Computing Devices.

Paralleling the discussion, above, in the section entitled “Hosted Application Utilization of Native Operating System Proxies in Multi-Operating System Mobile and Other Computing Devices,” and as discussed elsewhere herein, the hosted software applications 34′ utilizes its corresponding proxies 50′ to perform the following, by way of nonlimiting example:
present icons on the browser 15 graphical desktop of display/touch screen 24 for selection by the user;
present on display/screen 24 applications at least the frames of applications windows to contain output of the respective hosted software application 34′;
to relay to the hosted runtime environments 32 launch and activation requests, e.g., signaled by the user via the display/touch screen 24, browser 15′ and/or native operating system 14;
to relay to the hosted runtime environments 32 taps and other input made by the user to device 10 and specifically, for example, to display/touch screen 24, a keyboard, trackball, touch stick, other user input devices;
to effect bringing the hosted software applications to the virtual foreground in the hosted runtime environments 32.

The hosted software application 34′ can similarly use proxy 50′ executing in the browser 15′ for access to other resources available to it, e.g., of the native operating system 14 and native runtime environments 16, as well as of the hardware resources of the device 10

Thus, for example, a hosted software application 34′ that utilizes a still, video or other camera provided with device 10 (e.g., natively or otherwise) can access and/or alter pictures, movies of other image(s) and/or related data generated by that camera and/or by associated application resources 19 and/or runtime libraries 20 (and, more generally, by native runtime environments 16) through use of the proxy 50′. This can proceed as discussed above in the section entitled “Hosted Application Utilization of Native Operating System Proxies in Multi-Operating System Mobile and Other Computing Devices,” albeit, with the camera and other subsystems that form part of the hosted runtime environment 32 transferring buffer contents and messages/notifications with their counterparts in the native runtime environment 16 via JSON or other protocol communications.

By way of further nonlimiting example it will be appreciated that the browser-based proxy 50′ can be utilized by hosted software application 34′ to accesses a telephony-related services and/or related data provided by device 10 and/or its native runtime environments 16. This includes not only use of the so-called telephone function (i.e., to make and receive calls), but also telephone logs, address books and other contact information.

Coordination of Foreground Application Tasks in Multi-Executing Environment Mobile and Other Computing Devices.

In order to more fully merge the user experience, when proxy 50′ is brought to the foreground (e.g., as a result of a user tap on the application window for IO proxy 50, as a result of issuance of a notification with respect to that application or otherwise), it effects making the corresponding hosted software application 34′ active within the one or more hosted runtime environments 32, as if it had been brought to the foreground in them, utilizing the mechanisms discussed in the section entitled “Coordination of Foreground Application Tasks in Multi-Operating System Mobile and Other Computing Devices,” albeit with proxy 50′ notifying/querying the event handler 42 of hosted runtime environments 32 (via JSON or other protocol communications) regarding foregoing tasks in the browser/hosted environments, respectively.

Notification and Reply Adaptation for Hosted Applications in Multi-Executing Environment Mobile and Other Computing Devices.

Applications (e.g., 34′) executed in the hosted runtime environment that have counterpart proxies (e.g., 50′) executing in the native browser 15′ use a mechanism paralleling that discussed in the section entitled “Notification and Reply Adaptation for Hosted Applications in Multi-Operating System Mobile and Other Computing Devices” and elsewhere herein for enabling hosted applications to use and interact with common notification subsystems of the native operating system 14, runtime environments 16 and/or browser 15′, albeit with proxy 50′ communicating with the components of the hosted runtime environments 32 via JSON or other protocol communications and with adaptation layer 1104 and like functionality implemented to the extent possible in the hosted runtime environments 32.

### CONCLUSION

Described above and shown in the drawings are devices and methods meeting the desired objects, among others. Those skilled the art will appreciate that the embodiments described and shown here in our merely examples of the invention and that other embodiments, incorporating changes to those here, fall within the scope of the invention, as well.

In view thereof, what we claim is:

1. A computing device, comprising
A. a central processing unit that is coupled to a hardware interface including at least a display and that executes a native operating system including one or more native runtime environments within which one or more native software applications—including at least a browser—are executing, where each such native software application has instructions for execution under the native operating system,
B. the central processing unit additionally executes one or more applications and/or processes (collectively, “processes”) providing services that make up one or more hosted runtime environments, or portions thereof, within which one or more hosted software applications are executing, where each such hosted software application has instructions for execution under a hosted operating system that differs from the application execution environment defined within the browser and that may also differ from the native operating system,
C. one or more applications (“proxies”) executing within the browser, each corresponding to a respective one of the hosted software applications and each associated with an icon or other identifier that is presented on the hardware interface for selection by the user of the browser, responds to notification of such selection by activating the respective hosted software application.

2. A computing device, comprising:
A. a central processing unit that is coupled to a hardware interface that includes at least a display and that executes a native operating system including one or more native runtime environments within which one or more native software applications—including at least a browser—are executing, where each such native software application has instructions for execution under the native operating system,
B. the central processing unit additionally executes one or more applications and/or processes (collectively, “processes”) providing services that make up one or more hosted runtime environments, or portions thereof, within which one or more hosted software applications are executing, where each such hosted software application has instructions for execution under a hosted operating system that differs from the application execution environment defined within the browser and that may also differ from the native operating system,
C. one or more of the hosted software applications executing within the hosted runtime environments each executes instructions to interact with a user of the computing device via graphics generated by the respective hosted software application using a hosted windowing subsystem that is common to the one or more hosted runtime environments, where that windowing subsystem is coupled to, and loads, one or more buffers with those graphics,
D. one or more applications (“proxies”) executing within the browser, each corresponding to a respective one of the one or more hosted software applications, receives the graphics generated by the respective hosted software application and effects writing of those graphics to the video frame buffer for presentation on the display of the computing device.

3. A computing device, comprising:
A. a central processing unit that is coupled to a hardware interface that includes at least a display and that executes a native operating system including one or more native runtime environments within which one or more native software applications—including at least a browser—are executing, where each such native software application has instructions for execution under the native operating system,
B. the central processing unit additionally executes one or more applications and/or processes (collectively, “processes”) providing services that make up one or more hosted runtime environments, or portions thereof, within which one or more hosted software applications are executing, where each such hosted software application has instructions for execution under a hosted operating system that differs from the application execution environment defined within the browser and that may also differ from the native operating system,
C. one or more of the hosted software applications executing within the hosted runtime environments receive notifications of events from a hosted event handler subsystem that forms part of the one or more hosted runtime environments and that is common to the one or more hosted software applications,
D. one or more applications (“proxies”) executing within the browser, each corresponding to a respective one of the one or more hosted software applications, receive notification of user input made with respect to them from the one or more native runtime environments and/or from the browser,
E. each proxy responds to notification of user input by transmitting information with respect thereto received from the one or more native runtime environments to the hosted event handler, which notifies the hosted software application corresponding to the proxy that received that notification of that user input.

4. A computing device, comprising:
A. a central processing unit that is coupled to a hardware interface that includes at least a display and that executes a native operating system including one or more native runtime environments within which one or more native software applications—including at least a browser—are executing, where each such native software application has instructions for execution under the native operating system,
B. the central processing unit additionally executes one or more applications and/or processes (collectively, “processes”) providing services that make up one or more hosted runtime environments, or portions thereof, within which one or more hosted software applications are executing, where each such hosted software application has instructions for execution under a hosted operating system that differs from the application execution environment defined within the browser and that may also differ from the native operating system,
C. the native operating system and/or the one or more native runtime environments responds to user selection of an executing one of the native software applications by bringing a graphical window representing execution of that application to a foreground of the display and making it “active” within the one or more native runtime environments,
D. one or more applications (“proxies”) executing within the browser, each corresponding to a respective one of the hosted software applications, responds to begin brought to the foreground and/or being made active, by making the corresponding hosted software application active within the one or more hosted runtime environments as if it had been brought to the foreground in them.

5. A computing device, comprising
A. a central processing unit that is coupled to a hardware interface including at least a display and that executes a native operating system including one or more native runtime environments within which one or more native software applications—including at least a browser—are executing, where each such native software application has instructions for execution under the native operating system,
B. the central processing unit additionally executes one or more applications and/or processes (collectively, “processes”) providing services that make up one or more hosted runtime environments, or portions thereof, within which one or more hosted software applications are executing, where each such hosted software application has instructions for execution under a hosted operating system that differs from the application execution environment defined within the browser and that may also differ from the native operating system,
C. the one or more native runtime environments and/or the browser include a common native notification subsystem that is in communications coupling with applications executing under the browser and that marshals notifications generated by them for presentation to the user via the hardware interface,
D. the one or more hosted runtime environments include a common hosted notification subsystem that is in communications coupling with the hosted software applications and that marshals notifications generated by them for presentation to the user via the hardware interface,
E. a plurality of hosted software applications that each comprise instructions for execution under that hosted operating system execute on the central processing unit within one of more of the hosted runtime environments,
F. one or more of those applications generate notifications for presentation to a user of the device and transmit those notifications to the hosted notification subsystem, which is in communications coupling with an adaptation layer that adapts notifications received from the one or more hosted software applications for, and transmits them to, the common native notification subsystem, which effects their presentation on the hardware interface of notifications from the hosted software applications.
